(19) United States
(12) Patent Application Publication
(10) Pub. No.: US 2013/0017710 A1
(43) Pub. Date: Jan. 17, 2013

(54) ELECTRICAL CONNECTOR WITH ALIGNMENT MEMBER

(71) Applicant: Timothy W. Houtz, Etters, PA (US)

(72) Inventor: Timothy W. Houtz, Etters, PA (US)

(21) Appl. No.: 13/539,997

(22) Filed: Jul. 2, 2012

Related U.S. Application Data
(60) Provisional application No. 61/506,276, filed on Jul. 11, 2011.

(51) Int. Cl. H01R 13/64

(52) U.S. Cl. 439/374

(57) ABSTRACT

An electrical connector includes a connector housing, an organizer configured to be coupled to the connector housing and a plurality of leadframe assemblies supported by the connector housing. One or more of the leadframe assemblies can support respective ones of a plurality of electrical contacts that define respective mounting ends. The electrical connector can further include at least one alignment member disposed between the organizer and a respective one of the plurality of leadframe assemblies. The organizer can define a plurality of openings sized to receive the mounting ends of the plurality of electrical contacts. The organizer and the at least one alignment member can operate to align the plurality of leadframe assemblies along a mating direction, and the plurality of openings can operate to align respective mounting ends of the plurality of electrical contacts along a second direction that is substantially perpendicular with respect to the mating direction.

### CROSS-REFERENCE TO RELATED APPLICATIONS

This application claims the benefit of U.S. provisional patent application No. 61/506,276, filed Jul. 11, 2011, the disclosure of which is incorporated herein by reference in its entirety.

### BACKGROUND

Electrical connectors can be constructed using electrical contacts supported by leadframe assemblies, such as insert molded lead frame assemblies (IMLAs). When leadframe assemblies are not fully inserted into the connector housing of a complementary electrical connector, for example along a mating direction of the electrical connector, mounting ends of the electrical contacts supported by one or more of the leadframe assemblies may not be out of alignment with corresponding vias of an underlying substrate into which the mounting ends are disposed, along the mating direction, when the electrical connector is mounted to the substrate so as to place the electrical connector in electrical communication with the substrate.

Electrical connectors configured to support leadframe assemblies can also exhibit stack tolerances. For instance, in an electrical connector configured to support a plurality of leadframe assemblies spaced along a row direction, some of the leadframe assemblies may be slightly wider than others along the row direction. Accordingly, when the leadframe assemblies are disposed in the connector housing of the electrical connector, for instance stacked together in the connector housing along the row direction, the cumulative variances of the respective thicknesses of one or more of the leadframe assemblies may cause the mounting ends of the electrical contacts supported by one or more of the leadframe assemblies to be out of alignment with the corresponding vias of the underlying substrate along the row direction.

### SUMMARY

Described and illustrated herein are electrical connectors that can include respective alignment members configured to align the mounting ends of a plurality of electrical contacts supported by the electrical connector in one or both of a mating direction and a row direction relative to the electrical connector. For instance, the electrical connector can include a connector housing and a plurality of leadframe assemblies disposed adjacent to one another in the connector housing along the row direction. Each leadframe assembly can support respective ones of the plurality of electrical contacts. The electrical connector can further include an organizer that is configured to be attached to the connector housing. The connector housing, one or more of the leadframe assemblies, and the organizer can include complementary alignment members configured to align the respective mounting ends of the plurality of electrical contacts along one or both of the mating direction and the row direction. The alignment members of the organizer can be configured to allow the mounting ends of the plurality of electrical contacts to move along the mating direction when the leadframe assemblies are supported by the connector housing.

In accordance with an embodiment, an electrical connector configured to mate with a complementary electrical connector along a mating direction includes a plurality of leadframe assemblies. Each leadframe assembly includes a dielectric leadframe housing that defines an outer surface, and a plurality of electrical contacts supported by the leadframe housing. Each of the plurality of electrical contacts has a mounting end. The electrical connector further includes an organizer defining a plurality of openings. Each opening is configured to receive the mounting end of a corresponding one of the plurality of electrical contacts. The electrical connector further includes an alignment member disposed between the outer surface of at least one of the plurality of leadframe housings and the organizer such that the organizer contacts the alignment member so as to bias the at least one leadframe housing along the mating direction, thereby aligning the at least one leadframe housing with at least another one of the plurality of leadframe housings along a second direction that is perpendicular to the mating direction. The plurality of openings cause respective ones of the mounting ends of the plurality of electrical contacts to align relative to each other along the mating direction.

In accordance with another embodiment, an electrical connector configured to mate with a complementary electrical connector along a mating direction includes a connector housing defining a first abutment surface. The electrical connector further includes a plurality of leadframe assemblies configured to be supported by the connector housing. Each leadframe assembly has a leadframe housing. The leadframe housing of at least one of the plurality of leadframe assemblies defines an outer surface and a second abutment surface configured to abut the first abutment surface. The electrical connector further includes a bias surface that faces the outer surface. The electrical connector further includes an alignment member disposed between the outer surface and the bias surface. The alignment member defines a contact surface that is in mechanical communication with the bias surface. The alignment member is configured to compress from a first state to a second state. The outer surface and the second abutment surface are spaced from each other a first distance along the mating direction. The contact surface and the second abutment surface are spaced a second distance along the mating direction, the second distance longer than the first distance. The bias surface and the first abutment surface are spaced apart a third distance along the mating direction, the third distance between the first and second distances when 1) the alignment member is in the first state and 2) the bias surface defines a predetermined spatial relationship with respect to the connector housing. When the bias surface defines the predetermined spatial relationship, the bias surface applies a force to the contact surface that 1) compresses the alignment member from the first state to the second state, and 2) biases the at least one of the plurality of leadframe assemblies toward the first abutment surface.

In accordance with still another embodiment, a method includes the step of providing an electrical connector that includes a connector housing that defines a first abutment surface, an organizer configured to attach to the connector housing, and a plurality of leadframe housings configured to be supported by the connector housing. Each leadframe housing includes a housing body that defines a respective second abutment surface and an outer surface that is spaced from the second abutment surface. Each leadframe housing further includes an alignment member that projects from the outer surface. The method further includes the step of disposing the plurality of leadframe housings into the connector housing. The method further includes the step of attaching the organizer to the connector housing, such that the organizer biases the plurality of leadframe housings toward the first abutment surface so as to cause the respective second abutment surfaces to abut the first abutment surface.

### BRIEF DESCRIPTION OF THE DRAWINGS

The foregoing summary, as well as the following detailed description of example embodiments of the application, will be better understood when read in conjunction with the appended drawings, in which there is shown in the drawings example embodiments for the purposes of illustration. It should be understood, however, that the application is not limited to the precise arrangements and instrumentalities shown. In the drawings:

FIG. 1 is a perspective view of an electrical assembly constructed in accordance with an embodiment, the electrical assembly including a substrate and an electrical connector assembly mounted to the substrate;

FIG. 2 is a perspective section view of an electrical connector of the electrical connector assembly illustrated in FIG. 1, the electrical connector mounted to the substrate illustrated in FIG. 1;

FIG. 3A is a side elevation of a leadframe assembly constructed in accordance with a first embodiment, the leadframe assembly including a leadframe housing and a plurality of electrical signal contacts supported by the leadframe housing;

FIG. 3B is a side elevation view of a leadframe assembly including a leadframe housing constructed in accordance with a second embodiment, the leadframe assembly including a plurality of electrical signal contacts supported by the leadframe housing;

FIG. 3C is a side elevation view of a leadframe assembly constructed in accordance with a third embodiment, the leadframe assembly including a leadframe housing and a crosstalk shield supported by the leadframe housing;

FIG. 3D is a side elevation view of the leadframe assembly illustrated in FIG. 3C with the leadframe housing removed, exposing the crosstalk shield;

FIG. 4A is a perspective view of the electrical connector illustrated in FIG. 2;

FIG. 4B is a perspective view of the electrical connector illustrated in FIG. 4A, with the electrical connector supporting respective pluralities of the leadframe assemblies illustrated in FIGS. 3A-3C;

FIG. 5A is a perspective view of the electrical connector illustrated in FIG. 4B and an organizer configured to attach to the electrical connector;

FIG. 5B is a perspective view of the organizer illustrated in FIG. 5A;

FIG. 5C is a perspective view of the electrical connector illustrated in FIG. 5A, with the organizer attached to the electrical connector;

FIG. 5D is a side section view of the electrical connector illustrated in FIG. 4B;

FIG. 6 is a top elevation view of the substrate illustrated in FIG. 1;

FIG. 7A is a side elevation view of a first leadframe assembly constructed in accordance with an alternative embodiment and configured as a signal leadframe assembly;

FIG. 7B is a side elevation view of the first leadframe assembly illustrated in FIG. 7A, configured as a ground leadframe assembly;

FIG. 7C is a side elevation view of a second leadframe assembly constructed in accordance with the alternative embodiment and configured as a signal leadframe assembly;

FIG. 7D is a side elevation view of the second leadframe assembly illustrated in FIG. 7C, configured as a ground leadframe assembly;

FIG. 8A is a perspective view of an electrical connector constructed in accordance with the alternative embodiment;

FIG. 8B is a perspective view of the electrical connector illustrated in FIG. 8A, with the electrical connector supporting respective pluralities of the leadframe assemblies illustrated in FIGS. 7A-7D; and

FIG. 8C is a perspective view of the electrical connector illustrated in FIG. 8B, with an organizer constructed in accordance with the alternative embodiment attached to the electrical connector constructed in accordance with the alternative embodiment.

### DETAILED DESCRIPTION

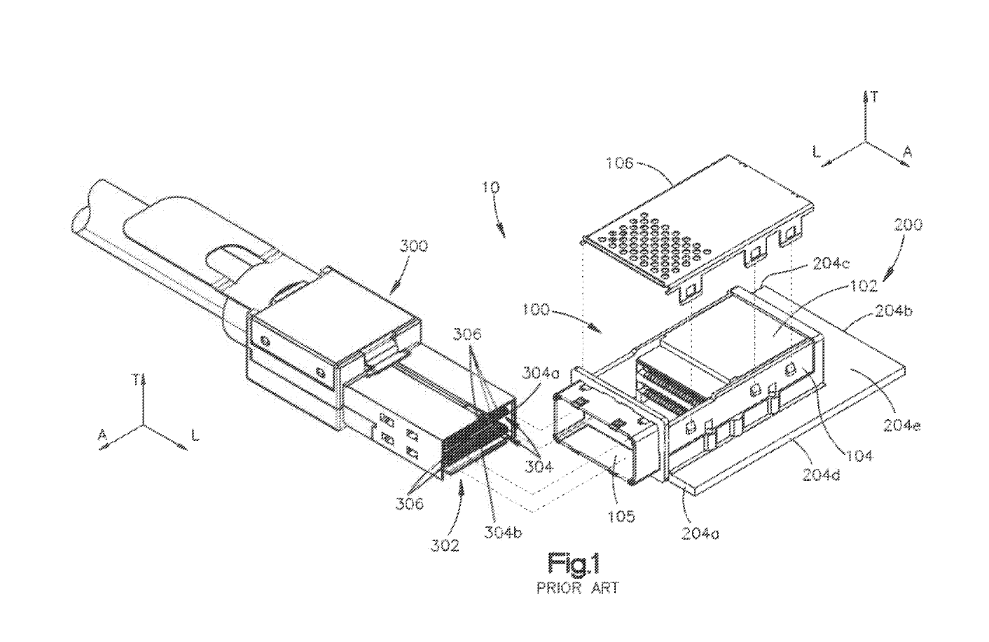

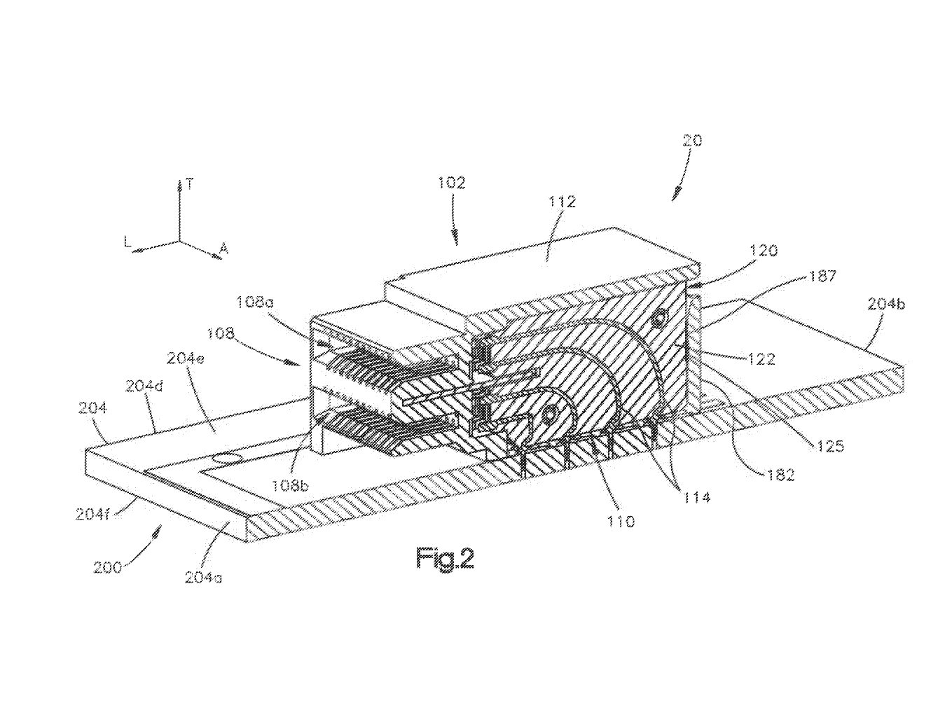

Referring initially to FIGS. 1-2, an electrical assembly 10 can include a substrate 200, such as a printed circuit board (PCB), and an electrical connector assembly 100 that can be shielded, and that is configured to be mounted to the substrate 200 so as to place the electrical connector assembly 100 in electrical communication with the substrate 200. The electrical assembly 10 can further include a complementary electrical component, for instance a complementary electrical connector 300 that can be shielded, and can be a cable connector, for example an optical transceiver. The complementary electrical connector 300 is configured to be mated to the electrical connector assembly 100, such that the electrical connector assembly 100 places the complementary electrical connector 300 in electrical communication with the substrate 200. Each of the substrate 200, the electrical connector assembly 100, and the complementary electrical connector 300 can be configured in accordance with one or both of the SFF-8642 Specification, Rev. 2.7, Feb. 26, 2010, and “Supplement to InfiniBand™ Architecture Specification Volume 2 Release 1.2.1” Annex A6: 120 Gb/s 12x Small Form-factor Pluggable (CXP), Interface Specification for Cables, Active Cables, & Transceivers, InfiniBand© Trade Association, September 2009, the disclosures of which are incorporated herein by reference in its entirety. In this regard, the electrical assembly 10 can be configured to operate as a CXP electrical assembly. It should be appreciated, however, that the electrical assembly 10, including any up to all of the components thereof, such as the electrical connector assembly 100, can be constructed in any suitable manner as desired. For instance, the electrical connector assembly 100 can be constructed in any suitable manner as desired, unless otherwise indicated.

In accordance with the illustrated embodiment, the electrical connector assembly 100 includes an electrical connector 102 that is configured to be mounted to the substrate 200 so as to place the electrical connector 102 in electrical communication with the substrate 200. The electrical connector 102 can be configured to mate with a complementary electrical component, such as the complementary electrical connector 300, so as to place the complementary electrical connector 300 in electrical communication with the electrical connector 102, and thus the substrate 200. The electrical connector 102 can include a connector housing 112 and a plurality of leadframe assemblies 120 supported by the connector housing 112. Each leadframe assembly 120 can include a leadframe housing 122 and a plurality of electrical contacts 114 supported by the leadframe housing 122. Each leadframe housing 122 can support an alignment member such as an alignment rib 125. The electrical connector 102 can further include an organizer 182 that is configured to be attached to the connector housing 112. The organizer can define a bias surface 187 that is configured to engage with the alignment ribs 125 of the leadframe housings 122 so as to cause respective mounting ends of the plurality of electrical contacts to be aligned with respect to the connector housing 112.

In accordance with the illustrated embodiment, the electrical connector 102 can be constructed as a right-angle connector that defines a mating interface 108 and a mounting interface 110 that is oriented substantially perpendicular to the mating interface 108. The mounting interface 110 can be configured to be mounted onto the substrate 200. The mating interface 108 can be configured to mate with a complementary mating interface of a complementary electrical component that is configured to be mated to the electrical connector 102, such as the complementary electrical connector 300. For example, the complementary electrical connector 300 defines a mating interface 302 comprising a pair of paddle cards 304 including a first paddle card 304a and a second paddle card 304b. Each of the first and second paddle cards 304a and 304b can be configured as printed circuit boards that define a respective plurality of electrically conductive, electrical contact pads 306 that are electrically connected to respective electrical traces of the first and second paddle cards 304a and 304b. Further in accordance with the illustrated embodiment, the mating interface 108 can include first and second receptacle pockets 108a and 108b, wherein the first receptacle pocket 108a can be positioned as an upper receptacle pocket configured to at least partially retain the first paddle card 304a, and the second receptacle pocket 108b can be positioned as a lower receptacle pocket configured to at least partially retain the second paddle card 304b.

The electrical connector assembly 100 can further include a guide frame housing 104 that is configured to be mounted to the substrate 200 such that the guide frame housing 104 at least partially encloses the electrical connector 102. The guide frame housing 104 can be configured to at least partially receive and to guide a complementary electrical component, such as the complementary electrical connector 300, during mating of the complementary electrical connector 300 to the electrical connector 102. For example, the guide frame housing 104 can include a receptacle sleeve 105 that is configured to receive the mating interface 302 of the complementary electrical connector 300 and to at least partially align the first and second paddle cards 304a and 304b with the first and second receptacle pockets 108a and 108b, respectively, when mating the complementary electrical connector 300 to the electrical connector 102.

Additionally, the guide frame housing 104 can be configured to at least partially surround at least one or both of the electrical connector 102 or the complementary electrical connector 300. The guide frame housing 104 can be constructed of any suitable dielectric or insulative material, such as plastic. The electrical connector assembly 100 can further include a shroud 106 that is configured to be attached to the guide frame housing 104, the shroud 106 configured to shield at least one or both of the electrical connector 102 or the complementary electrical connector 300, for example from electrical interference generated by other electrical components in a vicinity of the electrical assembly 10. Thus, the electrical connector assembly 100 can be configured as a shielded electrical connector assembly. The shroud 106 can be constructed of any suitable material, such as metal.

The connector housing 112 can be made of a dielectric or electrically insulative material and can be configured to support the plurality of electrical contacts 114. The plurality of electrical contacts 114 can include respective pluralities of signal contacts 116 and ground contacts 118. The plurality of electrical contacts 114 can further be supported by the plurality of leadframe assemblies 120 supported by the connector housing 112. The plurality of leadframe assemblies 120 can be constructed substantially the same or differently, as described in more detail below. Each leadframe assembly 120 can include a dielectric or electrically insulative leadframe housing 122 that carries respective ones of the plurality of electrical contacts 114. For instance, each leadframe assembly 120 can be configured as an insert molded leadframe assembly (IMLA) whereby the leadframe housing 122 is overmolded onto the respective ones of the plurality of electrical contacts 114. Alternatively, the respective ones of the plurality of electrical contacts 114 can be stitched into the leadframe housing 122 or otherwise supported by the leadframe housing 122. The electrical connector 102, for instance the plurality of leadframe assemblies 120, can include a dielectric material, such as air or plastic that electrically isolates individual ones of the plurality of electrical contacts 114 from one another.

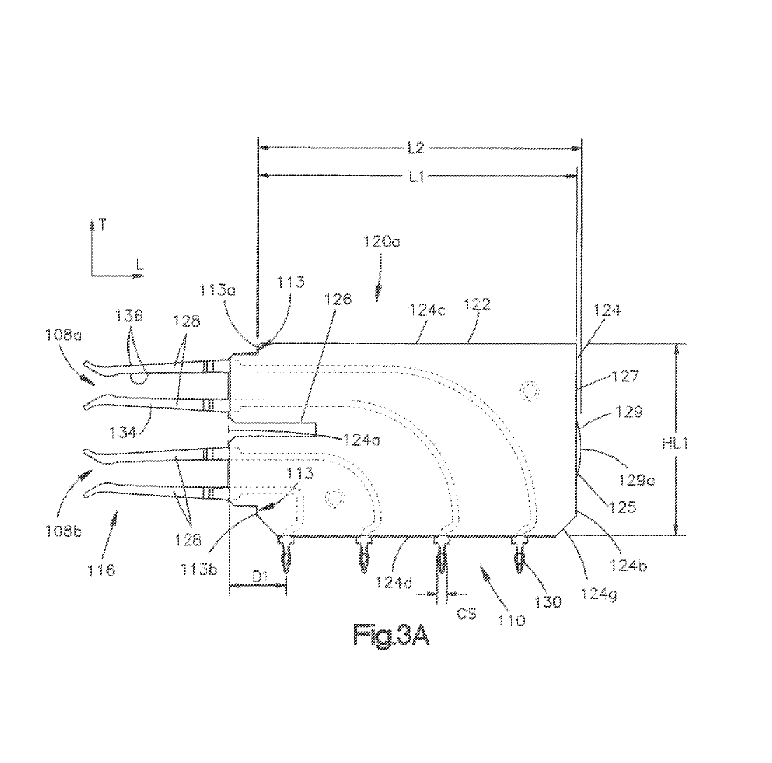

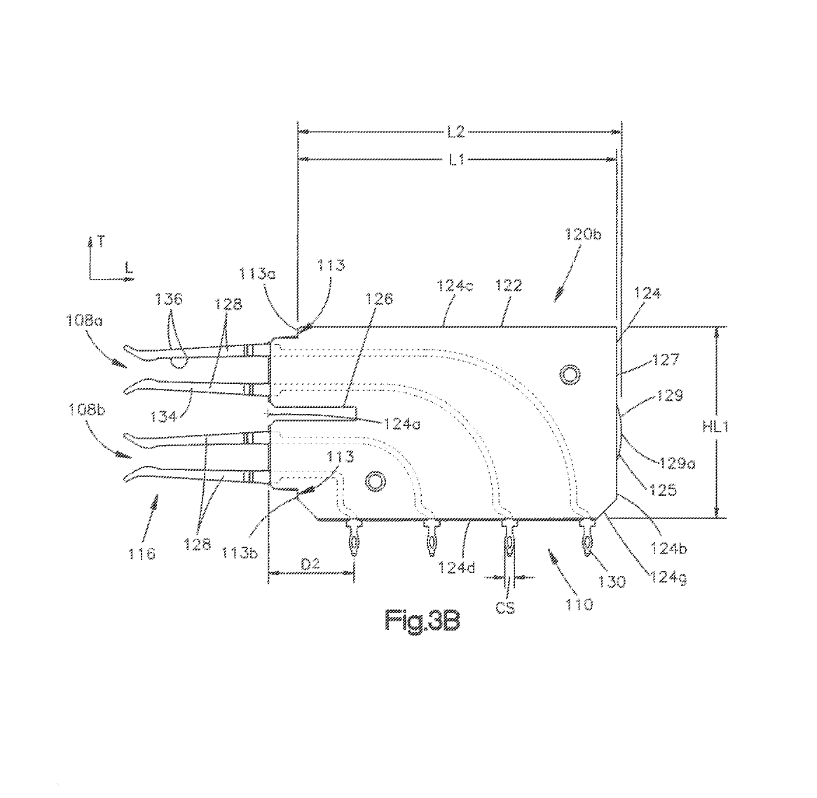

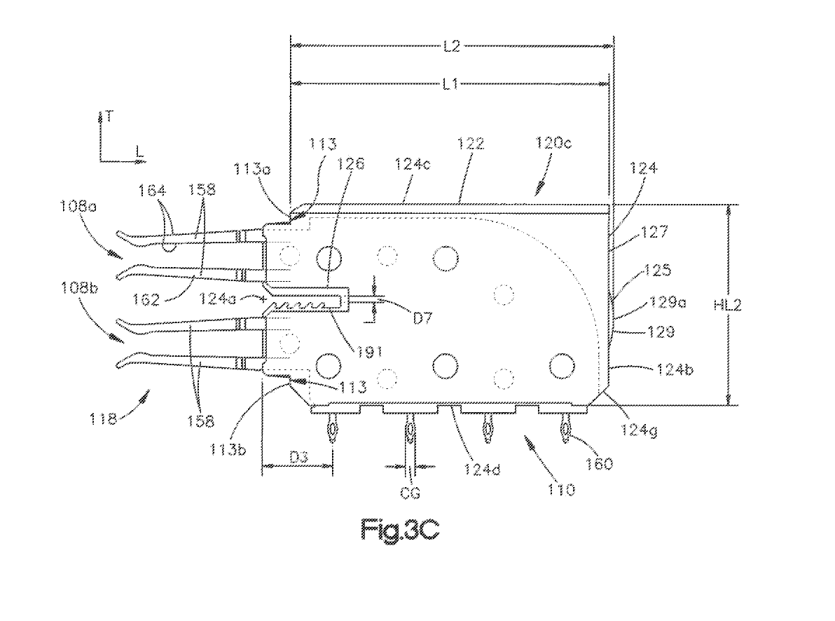

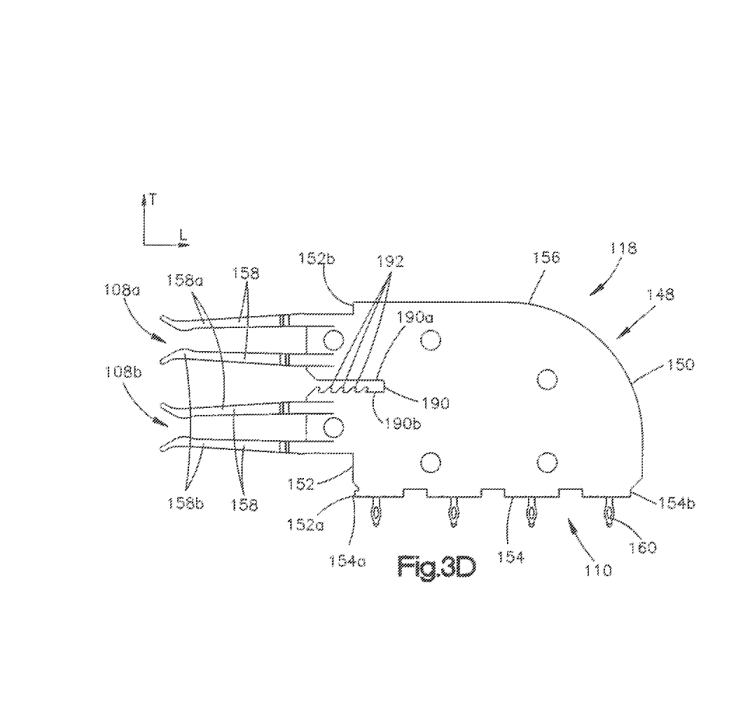

Referring now to FIGS. 3A-3D, in accordance with the illustrated embodiment the electrical connector 102 can include a plurality of leadframe assemblies 120. The plurality of leadframe assemblies 120 can include respective pluralities of first leadframe assemblies 120a configured as signal leadframe assemblies, second leadframe assemblies 120b configured as signal leadframe assemblies, and third leadframe assemblies 120c configured as ground leadframe assemblies. Each first, second, and third leadframe assembly 120a, 120b, and 120c includes a respective leadframe housing 122.

The leadframe housing 122 of each leadframe assembly 120 includes a housing body 124 that defines a front end 124a that is disposed proximate to the mating interface 108 of the electrical connector 102 when the leadframe assembly 120 is supported by the connector housing 112, a rear end 124b that is spaced from the front end 124a along a first direction that can define a longitudinal direction L, opposed first and second side surfaces 124e and 124f that are spaced apart from each other along a second direction that can define a lateral direction A that extends substantially perpendicular to the longitudinal direction L, an upper end 124c, and an opposed lower end 124d that is disposed proximate to the mounting interface 110 of the electrical connector 102 when the leadframe assembly 120 is supported by the connector housing 112. The lower end 124d is spaced from the upper end 124c along a third direction that can define a transverse direction T that extends substantially perpendicular to both the longitudinal direction L and the lateral direction A. It should be appreciated that in accordance with the illustrated embodiment, the longitudinal direction L and the lateral direction A are oriented horizontally, and the transverse direction T is oriented vertically, though it should be appreciated that the orientation of the electrical connector assembly 100 can vary during use. Unless otherwise specified herein, the terms “lateral,” “laterally,” “longitudinal,” “longitudinally,” “transverse,” and “transversely” are used to designate perpendicular directional components in the drawings to which reference is made.

Each leadframe housing 122, for instance the housing body 124, can define at least one alignment surface that is configured to engage with a complementary alignment surface so as to cause the leadframe housing 122 to be at least partially biased into alignment with respect to the connector housing 112, as described in more detail below. In accordance with the illustrated embodiment, the housing body 124 of each leadframe housing 122 defines an alignment surface 124g that is located substantially at the intersection of the rear end 124b and the lower end 124d, and is angularly offset with respect to both the transverse direction T and the longitudinal direction L. Furthermore, the housing body 124 of each leadframe assembly 120 can define a width WL along the lateral direction A, for instance as defined by the upper and lower ends 124c and 124d, respectively. In accordance with the illustrated embodiment, the respective leadframe housings 122 of the each of the first, second, and third leadframe assemblies 120a, 120b, and 120c, are constructed having substantially the same width WL. Additionally, the housing body 124 of each leadframe assembly 120 can define a height along the transverse direction T, for instance as defined by the upper and lower ends 124c and 124d, respectively. In accordance with the illustrated embodiment, the respective leadframe housings 122 of each of the first and second leadframe assemblies 120a and 120b, respectively are constructed having substantially the same height HL1, and the leadframe housing 122 of each of the third leadframe assemblies 120c is constructed having a height HL2 that is taller than the heights HL1 of the respective first and second leadframe assemblies 120a and 120b. The leadframe housings 122 of the plurality of leadframe assemblies 120 can be constructed of any suitable dielectric or insulative material as desired, for instance plastic. Each first leadframe assembly 120a can be configured to attach to a corresponding one of the second leadframe assemblies 120b when respective pluralities of first and second leadframe assemblies 120a and 120b are supported by the connector housing 112.

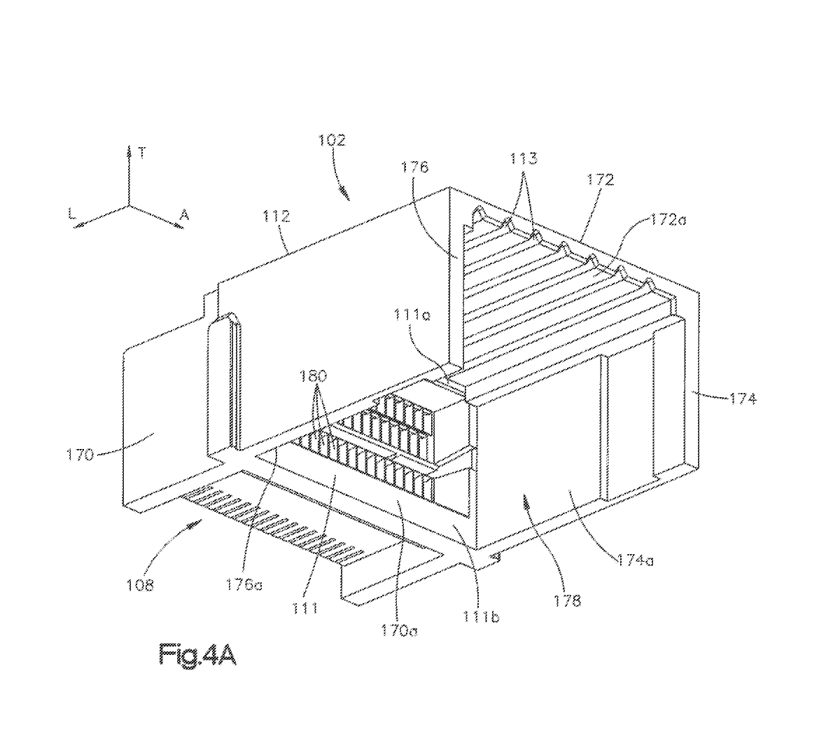

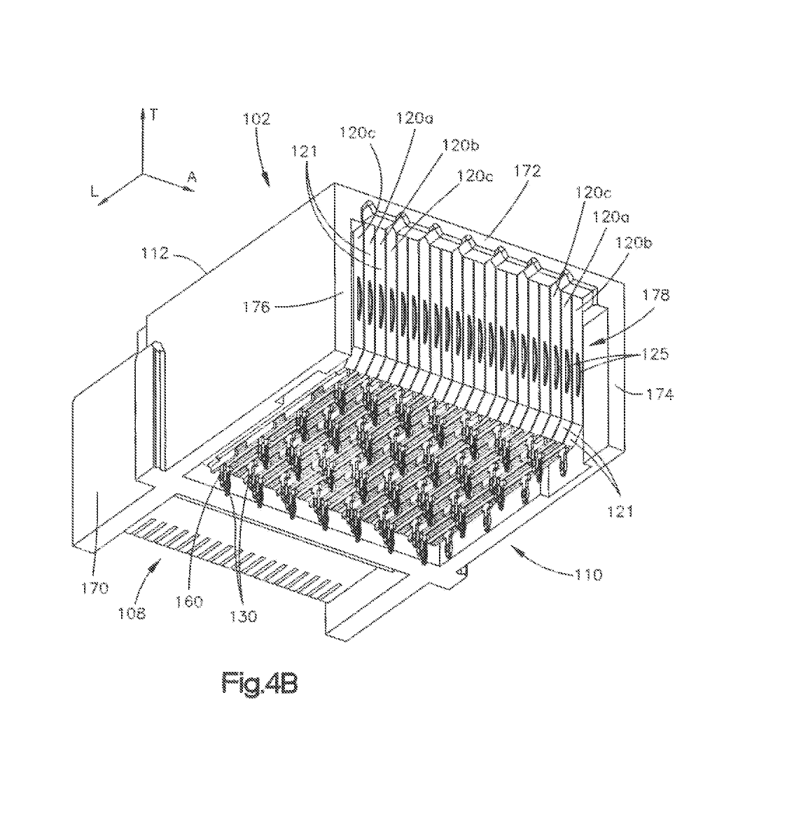

Referring now to FIGS. 3A-3C and 4A-4C, each of the plurality of signal contacts 116 includes a contact body that defines a mating end 128, an opposed mounting end 130 that is spaced from the mating end 128, and an intermediate portion that extends from the mating end 128 to the mounting end 130. In accordance with the illustrated embodiment, the mating end 128 of each of signal contact 116 protrudes forward along the longitudinal direction L from the front end 124a of the respective housing body 124 and is disposed proximate to, for instance substantially at, the mating interface 108, thus defining a respective portion of the mating interface 108. Furthermore, the mounting end 130 of each signal contact 116 protrudes downward along the transverse direction T from the lower end 124d of the respective housing body 124 and is disposed proximate to, for instance substantially at, the mounting interface 110, thus defining a respective portion of the mounting interface 110.

Each signal contact 116 can define a pair of opposed broadsides 134 and a pair of opposed edges 136 along at least a portion, such as substantially an entirety of a length of the contact body, for instance as defined by the mating end 128 and the mounting end 130, respectively. For example, in accordance with the illustrated embodiment, the mating end 128 of each signal contact 116 defines a pair of opposed broadsides 134 that are spaced apart from each other along the lateral direction A and a pair of opposed edges 136 that are spaced apart from each other along the transverse direction T, such that the mating end 128 of each signal contact 116 defines a substantially rectangular cross section. Each signal contact 116 has a thickness TS, for instance as defined by the opposed broadsides 134. In accordance with the illustrated embodiment, the plurality of signal contacts 116 are constructed having a substantially uniform thickness TS, but can be alternatively constructed as desired, for instance with one or more portions of varying thickness between the mating and mounting ends 128 and 130, respectively.

In accordance with the illustrated embodiment, the plurality of signal contacts 116 can define mounting ends 130 that are configured to electrically connect to respective electrical traces of the substrate 200 when the electrical connector 102 is mounted to the substrate 200. For instance, the illustrated mounting ends 130 define eye-of-the-needle press-fit tails that are configured to be inserted, or press-fit, into respective ones of the plurality of electrical signal vias 208 of the substrate 200. Each mounting end 130 can define a maximum cross-sectional dimension CS along the longitudinal direction L which can be for instance, a length between opposed outer edges of the mounting end 130 measured at a location where the opposed outer edges are spaced furthest from each other along the longitudinal direction L. It should be appreciated that the mounting ends 130 are not limited to the illustrated press-fit tails, and that the mounting ends 130 can alternatively be configured as press-fit tails, surface mount tails, or fusible elements such as solder balls.

The electrical connector 102 can be configured to be mated with, and unmated from, a complementary electrical component, for instance the complementary electrical connector 300, along a mating direction M that extends substantially parallel to the longitudinal direction L. In accordance with the illustrated embodiment, mating ends 128 of the plurality of signal contacts 116 define receptacle mating ends 128 that are configured to receive mating ends of complementary electrical contacts of a complimentary electrical component, such as the complementary electrical connector 300, so as to electrically connect to the complementary electrical contacts. Respective ones of the illustrated receptacle mating ends 128 can be configured to make contact with corresponding ones of the electrical contact pads 306 of the first and second paddle cards 304a and 304b of the complementary electrical connector 300 when the complementary electrical connector 300 is mated to the electrical connector 102, thereby placing the complementary electrical connector 300 in electrical communication with the electrical connector 102. In this regard, the electrical connector 102, and in particular the mating interface 108, can be said to be mating compatible with complementary electrical components constructed in accordance with SFF-8642 Specification, Rev. 2.7, Feb. 26, 2010.

With continued reference to FIGS. 3A-3B, in accordance with the illustrated embodiment the respective mating ends 128 of the signal contacts 116 of each of the first and second leadframe assemblies 120a and 120b are spaced apart from each other along the transverse direction T, such that each of the first and second leadframe assemblies 120a and 120b defines a respective column of signal contacts 116. Furthermore, the respective mounting ends 130 of the signal contacts 116 of each of the first and second leadframe assemblies 120a and 120b are spaced apart from each other along the longitudinal direction L, such that the mounting interface 110 is oriented substantially perpendicular to the mating interface 108. In this regard, each of the plurality of signal contacts 116 is configured as right-angle signal contacts. It should be appreciated that the signal contacts 116 can be differently constructed, for instance as vertical signal contacts, such that the mounting interface 110 of the electrical connector 102 is oriented substantially parallel to the mating interface 108.

Referring now to FIGS. 3C-3D, the leadframe housing 122 of each of the third leadframe assemblies 120c can include a guide member that is configured to be received by the connector housing 112, as described in more detail below. In accordance with the illustrated embodiment, the guide member includes a ridge 119 that extends out from the upper end 124c of the housing body 124 along the transverse direction T, such that leadframe housing 122 of each of the third leadframe assemblies defines a height HL2 that is taller than the respective heights HL1 of each of the first and second leadframe assemblies 120a and 120b. The ridge 119 can extend from a location proximate the front end 124a of the housing body 124 to a location proximate the rear end 124b, for instance substantially at the rear end 124b, and has a substantially triangular cross section. It should be appreciated, however, that the guide member is not limited to the illustrated ridge 119, and that the guide member can be alternatively constructed using any other suitable geometry as desired.

Each third leadframe assembly 120c can include a ground contact 118 that is configured as an electrically conductive crosstalk shield 148. Each crosstalk shield 148 includes a shield body 150 includes a plurality of ground mating ends 158 that extend forward from the shield body 150 along the longitudinal direction L and a plurality of ground mounting ends 160 that extend downward from the shield body 150 along the transverse direction T. The ground mating ends 158 of the plurality of crosstalk shields 148 can be disposed proximate to, for instance substantially at, the mating interface 108, and can define a respective portion of the mating interface 108. Similarly, the ground mounting ends 160 of each of the plurality of crosstalk shields 148 can be disposed proximate to, for instance substantially at, the mounting interface 110, and can define a respective portion of the mounting interface 110. In accordance with the illustrated embodiment, the ground mating ends 158 of each crosstalk shield 148 can protrude forward along the longitudinal direction L from the front end 124a of the housing body 124, and the ground mounting ends 160 of each crosstalk shield 148 can protrude downward along the transverse direction T from the lower end 124d of the housing body 124. The leadframe housing 122 of each third leadframe assembly 120c can be overmolded onto the crosstalk shield 148, such that the leadframe housing 122 substantially encloses the shield body 150. Alternatively, the crosstalk shield 148 of each third leadframe assembly can be stitched into the leadframe housing 122 or otherwise supported by the leadframe housing 122.

The ground mating ends 158 of each crosstalk shield 148 are spaced apart from each other along the transverse direction T such that the ground mating ends 158 of each third leadframe assembly 120c define a respective column of ground mating ends 158. Similarly, the ground mounting ends 160 are spaced apart from each other along the longitudinal direction L. In accordance with the illustrated embodiment, each crosstalk shield 148 can be disposed adjacent to at least one column of signal contacts 116, such as a pair of columns of signal contacts 116, or can be disposed between a first pair of columns of signal contacts 116 and a second pair of columns of signal contacts 116, in the connector housing 112. In accordance with the illustrated embodiment, each ground mating ends 158 of each crosstalk shield 148 defines a pair of opposed broadsides 162 that are spaced apart from each other along the lateral direction A and a pair of opposed edges 164 that are spaced apart from each other along the transverse direction T, such that each ground mating end 158 defines a substantially rectangular cross section. Each ground mating end 158 has a thickness TG, for instance as defined by the opposed broadsides 162. In accordance with the illustrated embodiment, the thickness TG of the respective ground mating ends 158 of each crosstalk shield 148 is substantially equal to the thickness TS of the signal contacts 116.

In accordance with the illustrated embodiment, the ground mating ends 158 of each of the plurality of crosstalk shields 148 can define receptacle ground mating ends 158 that are constructed substantially identically to the mating ends 128 of the plurality of signal contacts 116, such that the ground mating ends 158 are configured to receive mating ends of complementary electrical contacts of a complimentary electrical component, for instance the complementary electrical connector 300, so as to electrically connect to the complementary electrical contacts. Respective ones of the illustrated receptacle ground mating ends 158 can be configured to make contact with corresponding ones of the electrical contact pads 306 of the first and second paddle cards 304a and 304b of the complementary electrical connector 300 when the complementary electrical connector 300 is mated to the electrical connector 102, thereby placing the complementary electrical connector 300 in electrical communication with the electrical connector 102. In this regard, the electrical connector 102, and in particular the mating interface 108 of the electrical connector 102, can be said to be mating compatible with complementary electrical components constructed in accordance with SFF-8642 Specification, Rev. 2.7, Feb. 26, 2010.

Because the mating ends 128 of the plurality of signal contacts 116 and the ground mating ends 158 of the plurality of crosstalk shields 148 are configured as receptacle mating ends and receptacle ground mating ends, respectively, the electrical connector 102 can be referred to as a receptacle electrical connector. Furthermore, because the mating interface 108 is oriented substantially perpendicular to the mounting interface 110, the electrical connector 102 can be referred to as a right-angle electrical connector. However it should be appreciated that the electrical connector 102 can alternatively be provided in any desired configuration so as to electrically connect an underlying substrate, such as the substrate 200, to a complementary electrical component, such as the complementary electrical connector 300. For instance, the electrical connector 102 can alternatively be constructed as a plug or header electrical connector with electrical contacts 114 having spade, or plug mating ends and ground mating ends configured to be plugged into, or received by complementary receptacle mating ends of the electrical contacts of a complementary electrical connector that is to be mated to the electrical connector 102. Additionally, the electrical connector 102 can be configured as a vertical connector, whereby the mating interface 108 is oriented substantially parallel to the mounting interface 110.

Further in accordance with the illustrated embodiment, the plurality of ground mounting ends 160 can be constructed substantially identically to the mounting ends 130 of the plurality of signal contacts 116, such that plurality of ground mounting ends 160 are configured to electrically connect to respective electrical traces of the substrate 200 when the electrical connector 102 is mounted to the substrate 200. The illustrated ground mounting ends 160 define eye-of-the-needle press-fit tails that are configured to be inserted, or press-fit, into respective ones of the plurality of electrical ground vias 210 of the substrate 200. Each ground mounting end 160 can define a maximum cross-sectional dimension CG along the longitudinal direction L which can be for instance, a length between opposed outer edges of the ground mounting end 160 measured at a location where the opposed outer edges are spaced furthest from each other along the longitudinal direction L. In accordance with the illustrated embodiment, the maximum cross-sectional dimension CG is substantially equal to the maximum cross-sectional dimension CS of each signal contact 116. It should be appreciated that the ground mounting ends 160 are not limited to the illustrated press-fit tails, and that the ground mounting ends 160 can alternatively be configured as press-fit tails, surface mount tails, or fusible elements such as solder balls.

Referring now to FIGS. 4A-4B, the connector housing 112 includes a contact block 170 that at least partially defines the mating interface 108, including the first and second receptacle pockets 108a and 108b, and is configured to at least partially receive the plurality of electrical contacts 114. In accordance with the illustrated embodiment, the contact block 170 defines an inner surface 170a. The connector housing 112 further includes an upper wall 172 that extends rearward an upper end of the contact block 170 along the longitudinal direction L. The upper wall 172 defines an inner surface 172a and an opposed outer surface 172b that is spaced from the inner surface 172a along the transverse direction T. The illustrated connector housing 112 further includes opposed first and second side walls 174 and 176, respectively, that are spaced from each other along the lateral direction A and that extend rearward from opposed sides of the contact block 170 and downward from opposed sides of the upper wall 172. The first and second side walls 174 and 176 define respective inner surfaces 174a and 176a.

The contact block 170, the upper wall 172, and the first and second side walls 174 and 176 can at least partially define a void 178 that is configured to receive the plurality of leadframe housings 122, including the respective pluralities of first, second, and third leadframe assemblies 120a, 120b, and 120c. In accordance with the illustrated embodiment, the respective inner surfaces 170a, 172a, 174a, and 176a of the contact block 170, the upper wall 172, the first side wall 174, and the second side wall 176, respectively, face the void 178. The contact block 170 can be configured to at least partially receive the mating ends 128 of the plurality of signal contacts 116 and the ground mating ends 158 of the plurality of crosstalk shields 148. For example, the contact block 170 can further define a plurality of slots 180 that extend into the first and second receptacle pockets 108a and 108b along the longitudinal direction L and are open to the void 178. Each slot 180 can be configured to receive a respective one of the mating ends 128 of the plurality of signal contacts 116 or a respective one of the ground mating ends 158 of the plurality of crosstalk shields 148. In this regard, it can be said that the void 178 extends forward into the contact block 170, for instance into the inner surface 170a of the contact block 170. The connector housing 112 can be constructed of any suitable dielectric or insulative material as desired, for instance plastic.

Each of the first leadframe assemblies 120a can be disposed adjacent to a corresponding one of the second leadframe assemblies 120b as supported in the connector housing 112, such that the first and second leadframe assemblies 120a and 120b define respective pairs 121 that each include a first leadframe assembly 120a and a second leadframe assembly 120b. The signal contacts 116 of the first and second leadframe assemblies 120a and 120b of each pair 121 can define at least one differential signal pair, such as a plurality of differential signal pairs. In accordance with the illustrated embodiment, each pair 121 of first and second leadframe assemblies 120a and 120b can define a respective plurality of differential signal pairs 117 that can be broadside-coupled, such that the broadsides 134 of the signal contacts 116 of each differential signal pair 117 face each other, though it should be appreciated that the plurality of signal contacts 116 can be alternatively configured as desired. For example, the signal contacts 116 of at least one pair 121, such as each pair 121 of first and second leadframe assemblies 120a and 120b can be configured as edge-coupled differential signal pairs spaced along the column direction C, such that the edges 136 of the signal contacts 116 of each differential signal pair 117 face each other. Alternatively still, the signal contacts 116 can be configured to define single-ended signal contacts.

In accordance with the illustrated repeating pattern of leadframe assemblies 120 disposed in the void 178 of the connector housing 112, each pair 121 of first and second leadframe assemblies 120a and 120b is separated from an adjacent pair 121 of first and second leadframe assemblies 120a and 120b by a third leadframe assembly 120c. Thus, a respective one of the plurality of crosstalk shields 148 is disposed between the signal contacts 116 of each pair 121 of first and second leadframe assemblies 120a and 120b and a successive pair 121 of first and second leadframe assemblies 120a and 120b. Two pairs 121 of first and second leadframe assemblies 120a and 120b can be said to be disposed successively in the void 178 when no other pairs 121 are disposed between the two pairs 121 of first and second leadframe assemblies 120a and 120b. Each of the plurality of crosstalk shields 148 can operate to shield the differential signal pairs 117 of a respective pair 121 of first and second leadframe assemblies 120a and 120b from electrical interference generated by the differential signal pairs 117 of other pairs 121 of first and second leadframe assemblies 120a and 120b disposed in the void 178. It should be appreciated that the electrical connector 102 is not limited to the illustrated arrangement of the plurality of leadframe assemblies 120 in the void 178, and that the electrical connector 102 can be alternatively provided with any other suitable arrangement of first, second, or third leadframe assemblies 120a, 120b, or 120c, in any combination as desired.

Referring again to FIGS. 4A-4B The connector housing 112 can include at least one guide member, such as a plurality of guide members configured to receive complementary guide members supported by respective ones of the plurality of leadframe assemblies 120. For example, in accordance with the illustrated embodiment, the upper wall 172 of the connector housing 112 defines a plurality of channels 113 that are recessed into the inner surface 172a along the transverse direction T, each channel 113 sized to receive a corresponding one of the plurality of third leadframe assemblies 120c. The channels 113 are spaced apart from each other along the lateral direction A, such that when respective third leadframe assemblies 120c are disposed in adjacent channels 113, the first side surface 124e of a first one of the respective third leadframe assemblies 120c is spaced from the second side surface 124f of the second one of the respective third leadframe assemblies 120c that is disposed adjacent the first one of the respective third leadframe assemblies 120c a distance such that a pair 121 of first and second leadframe assemblies 120a and 120b can be disposed between the adjacent third leadframe assemblies 120c.

For example, the plurality of leadframe assemblies 120, including respective ones of the pluralities of first, second, and third leadframe assemblies 120a, 120b, and 120c, can be disposed into the void 178 of the connector housing 112, adjacent to one another, along the lateral direction A, such that the ridge 119 of each third leadframe assembly 120c is received in a corresponding one of the plurality of channels 113, and such that the mating ends 128 of the plurality of signal contacts 116 of the pluralities of first and second leadframe assemblies 120a and 120b, and the ground mating ends 158 of the plurality of crosstalk shields 148 of the plurality of third leadframe assemblies 120c, are received in corresponding ones of the slots 180. In accordance with the illustrated embodiment, the plurality of leadframe assemblies 120 are disposed into the void 178 in a repeating pattern that includes a third leadframe assembly 120c, followed by a first leadframe assembly 120a disposed adjacent to the third leadframe assembly 120c, followed by a second leadframe assembly 120b disposed adjacent to the first leadframe assembly 120a.

The pattern of third, first, and second leadframe assemblies 120c, 120a, 120b, respectively, disposed adjacent to one another, is repeated from left to right across the void 178, between the second and first side walls 176 and 174 of the connector housing 112. In this regard, the repeating pattern of leadframe assemblies 120 defines a repeating pattern of ground leadframe assembly, signal leadframe assembly, signal leadframe assembly, from left to right across the void 178, from the second side wall 176 to the first side wall 174 of the connector housing 112.

The connector housing 112 can define at least one abutment surface that is configured to abut with complementary abutment surfaces defined by respective ones of the plurality of leadframe assemblies 120 so as to align the plurality of leadframe assemblies 120, and thus the mounting ends 130 and ground mounting ends 160 of the plurality of leadframe assemblies 120, with respect the connector housing 112. The connector housing 112 can define the at least one abutment surface at any suitable location as desired, such as in the void 178. In accordance with the illustrated embodiment, the inner surface 170a of the contact block 170 defines an abutment surface that can be a first abutment surface 111. In accordance with the illustrated embodiment, the first abutment surface 111 has two portions including a first or upper portion 111a disposed substantially at an upper end of the contact block 170 and a second or lower portion 111b that is spaced from the upper portion 111a along the transverse direction T and is disposed substantially at a lower end of the contact block 170. Further in accordance with the illustrated embodiment, the inner surface 170a of the contact block 170, and thus the first abutment surface 111, is substantially coplanar with a plane defined by the transverse direction T and the lateral direction A. The respective upper and lower portions 111a and 111b of the first abutment surface 111 can at least partially define the void 178. It should be appreciated that the connector housing 112 is not limited to the illustrated first abutment surface, and that connector housing 112 can be alternatively constructed having any other suitable first abutment surface or surfaces as desired.

Referring now to FIGS. 3A-3C, the leadframe housings 122 of each of the first, second, and third leadframe assemblies 120a, 120b, and 120c, respectively, can define at least one abutment surface that is configured to abut with the first abutment surface 111 of the connector housing 112. In accordance with the illustrated embodiment, the leadframe housing 122 of each leadframe assembly defines an abutment surface that can be a second abutment surface 123. The illustrated second abutment surface 123 has two portions including a first or upper portion 123a disposed substantially at the upper end 124c of the housing body 124 of the leadframe housing 122 and a second or lower portion 123b that is spaced from the upper portion 123a along the transverse direction T and is disposed substantially at the lower end 124d of the housing body 124. The upper and lower portions 123a and 123b, respectively, of the second abutment surface 123, are located proximate the front end 124a of the housing body 124 of the leadframe housing 122, for instance closer to the front end 124a than to the rear end 124b, and are located an equal distance from the front end 124a, such that the second abutment surface 123 is substantially coplanar with the plane defined by the transverse direction T and the lateral direction A.

The upper portion 123a of the second abutment surface 123 can be configured to abut with the upper portion 111a of the first abutment surface 111 and the lower portion 123b of the second abutment surface 123 can be configured to abut with the lower portion 111b of the first abutment surface 111. When the first and second abutment surfaces 111 and 123, such as the respective portions of the first and second abutment surfaces 111 and 123, respectively, abut each other, the respective front ends 124a of the housing bodies 124 of the leadframe housings 122 of the plurality of leadframe assemblies 120 are disposed at substantially the same longitudinal position, and thus are aligned with each other along the lateral direction A, and the plurality of leadframe assemblies 120 can be said to be fully inserted with respect to the connector housing 112. Accordingly, a line that extends along the lateral direction A can substantially pass through the respective front ends 124a of the leadframe housings 122 of each of the plurality of leadframe assemblies 120. In this regard, the first abutment surface 111 can serve as a datum in measuring whether one or more select ones of the plurality of leadframe assemblies 120 are fully inserted with respect to the connector housing 112. When the plurality of leadframe assemblies 120 are aligned with respect to each other along the lateral direction A, the mounting ends 130 and ground mounting ends 160, respectively, of the plurality of leadframe assemblies 120 are likewise longitudinally aligned with respect to corresponding ones of the plurality of vias 206 of the substrate 200. It should be appreciated that the respective leadframe housings 122 of the first, second, and third leadframe assemblies 120a, 120b, and 120c are not limited to the illustrated second abutment surface, and that the respective leadframe housings 122 of the plurality of leadframe assemblies 120 can be alternatively constructed having any other suitable second abutment surface or surfaces as desired.

The electrical connector 102 can include at least one alignment member that can be a first alignment member, the first alignment member configured to cause the first abutment surface 111 of the connector housing 112 and the respective second abutment surfaces 123 of the plurality of leadframe assemblies 120, respectively, to abut one another, thereby ensuring proper alignment of the plurality of leadframe assemblies 120 with respect to the connector housing 112, and thus proper alignment of the mounting ends 130 of the signal contacts and the ground mounting ends 160 of the crosstalk shields 148 with respect to corresponding ones of the plurality of vias 206 of the substrate 200. For example, each leadframe housing 122 can include at least one first alignment member that is configured to receive a biasing force that causes the leadframe assembly 120 to move forward toward the contact block 170 within the connector housing 112, along the mating direction M, until the second abutment surface 123 abuts the first abutment surface 111.

Each leadframe housing 122 can include at least one first alignment member such as an alignment rib 125 supported by the housing body 124 of the leadframe housing 122. In accordance with the illustrated embodiment, the rear end 124b of each leadframe housing 122 defines a rearward-facing outer surface 127 and the alignment rib 125 projects out from the outer surface 127, and thus out with respect to the rear end 124b of the leadframe housing 122. The outer surface 127 of each of the illustrated leadframe housings 122 is oriented substantially perpendicular with respect to the mounting interface 110 of the electrical connector 102. The alignment rib 125 can operate as a spacer that is configured to laterally align the front end 124a of the leadframe housing 122 of a select one of the plurality of leadframe assemblies 120 with respect to the respective front ends 124a of the leadframe housings 122 of other ones of the plurality of leadframe assemblies 120. Alternatively, the alignment rib 125 can extend outward from a respective surface defined proximate to, or instance substantially at the front end 124a of the housing body 124, and can operate as a spacer that is configured to laterally align the rear end 124b of the leadframe housing 122 of a select one of the plurality of leadframe assemblies 120 with respect to the respective rear ends 124b of the leadframe housings 122 of other ones of the plurality of leadframe assemblies 120. Thus, it should be appreciated that the alignment rib 125 can extend from any end of the leadframe housing 122 as desired so as to cause a substantially opposite end of the leadframe housing 122 to align with the leadframe housings 122 of other ones of the plurality of leadframe assemblies 120.

In accordance with the illustrated embodiment, the alignment rib 125 of each leadframe housing 122 projects longitudinally outward, or rearward, from the rear end 124b of the housing body 124 of the leadframe housing 122, and in particular projects out from the outer surface 127. The illustrated alignment rib 125 is elongate in the transverse direction T, and defines a width along the lateral direction that is thinner than the width WL of the leadframe housing 122. The alignment rib 125 can be along the outer surface 127 at any location as desired. For example, the alignment rib 125 can be located substantially at the transverse midpoint of the rear end 124b of the housing body 124, defined as a location that is substantially equidistant between the upper and lower ends 124c and 124d, respectively, of the housing body 124. In accordance with the illustrated embodiment, the alignment rib is disposed along the outer surface 127 at a location that is closer to the lower end 124d than the upper end 124c of the housing body 124, such that at least a portion of the alignment rib 125 overlaps the transverse midpoint of the rear end 124b. In accordance with the illustrated embodiment, the alignment ribs 125 are disposed at substantially the same location on the leadframe housings 122 of each of the respective first, second, and third leadframe assemblies 120a, 120b, and 120c. It should be appreciated that the alignment rib 125 can alternatively be disposed at any other suitable location along the outer surface 127 as desired. For example, the alignment ribs 125 can be disposed at a first location on one or more of the leadframe housings 122 of the respective first, second, and third leadframe assemblies 120a, 120b, and 120c and can be disposed at a second location on one or more of the leadframe housings 122 of the corresponding first, second, and third leadframe assemblies 120a, 120b, and 120c that is different than the first location.

Each alignment rib 125 can define a contact surface 129 that is configured to accept a biasing force and to transfer the biasing force to the leadframe housing 122, and thus to the leadframe assembly 120, so as to cause the leadframe assembly 120 to move along the mating direction M within the connector housing 112. In accordance with the illustrated embodiment, the alignment rib 125 defines a curved, generally arc shaped contact surface 129 profiles that protrudes from the leadframe housing 122 furthest along the longitudinal direction L at a select location 129a that can be an apex of the contact surface 129, such as substantially at the transverse midpoint of the alignment rib 125. The contact surface 129 can taper the select location 129a toward the outer surface 127 of the housing body 124 at opposed locations outwardly spaced along the transverse direction T from the select location 129a.

The alignment rib 125 can be configured to be compressible, such that when a biasing force is applied to the contact surface 129, for instance at the select location 129a, the select location 129a is compressed forward toward the outer surface 127 of the housing body 124. Compression of one or more of the alignment ribs 125 of the respective leadframe housings 122 can assist in alignment of the leadframe assemblies 120 with respect to the connector housing 112, for example by compensating for size mismatches among the leadframe housings 122 that may be introduced during the manufacturing process of components of the electrical connector, or compensating for errors introduced during assembly of the electrical connector 102. Alternatively, the alignment rib 125 can be configured to be rigid, such that the alignment rib 125 resists compression under application of a biasing force. It should be appreciated that the leadframe housings 122 of the leadframe assemblies 120 are not limited to the illustrated alignment rib 125. For example, the leadframe housings 122 can define alignment ribs 125 having alternative geometries, can define the alignment rib 125 at different transverse locations along the outer surface 127, can define respective pluralities of alignment ribs 125 on a single leadframe housing 122, or the like, in any combination as desired.

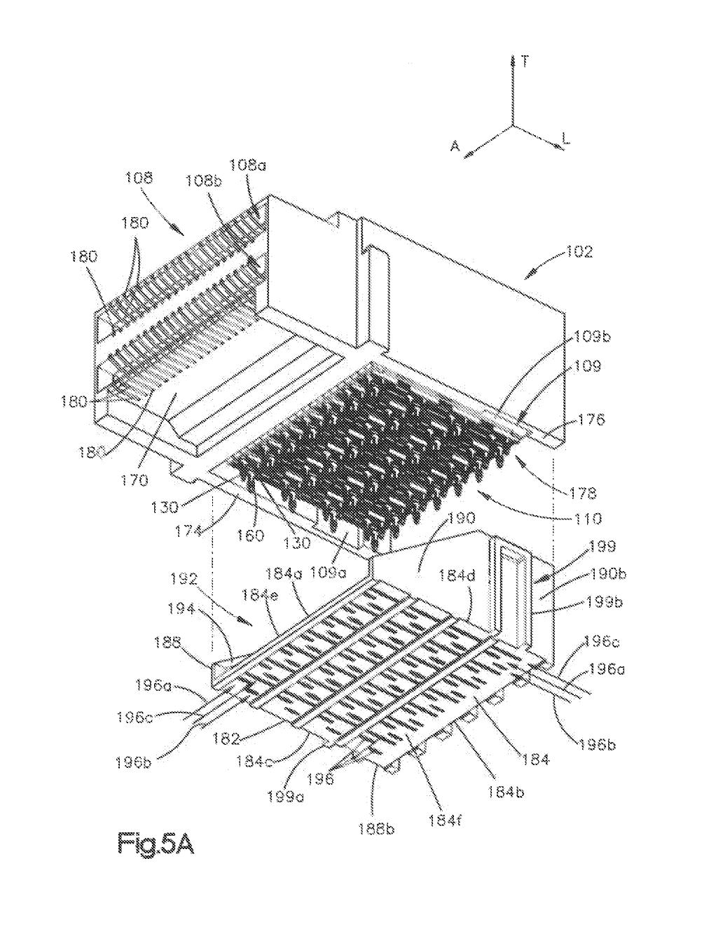

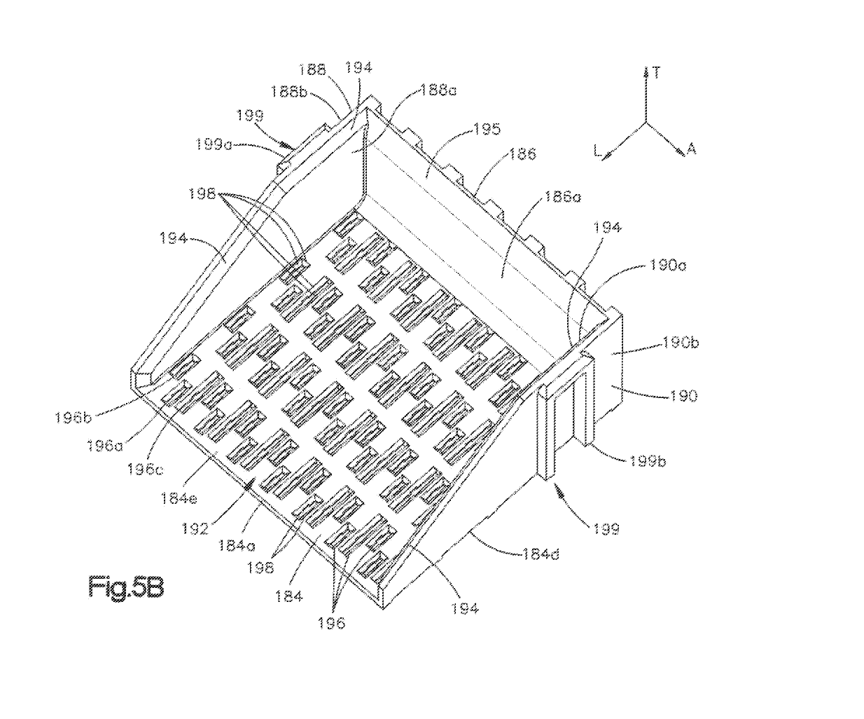

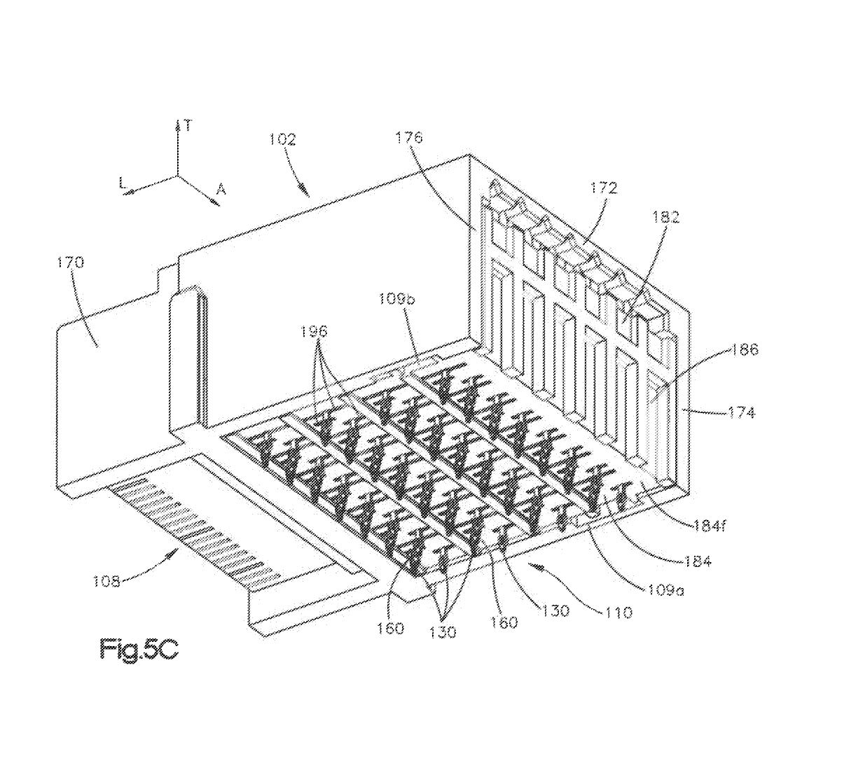

Referring again to FIGS. 5A-5D, in accordance with the illustrated embodiment, the electrical connector 102 can include at least one second alignment member such as an organizer 182 that is configured to attach to the connector housing 112 so as to at least partially align the plurality of leadframe assemblies 120 with respect to the connector housing 112, thereby at least partially aligning respective ones, such as all of the mounting ends 130 of the signal contacts 116 and respective ones, such as all of the and ground mounting ends 160 of the crosstalk shields 148 with respect to the mounting interface 110. The organizer 182 can include a lower wall that can be a base 184 of the organizer 182. The base 184 can define a front end 184a, a rear end 184b that is spaced from the front end 184a along the longitudinal direction L, opposed first and second sides 184c and 184d that are spaced from each other along the lateral direction A, an inner surface 184e, and an outer surface 184f that is spaced from the inner surface 184e along the transverse direction T.

The organizer 182 can further include a rear wall 186 that extends upward along substantially the transverse direction T from the rear end 184b of the base 184, such that the rear wall 186 is oriented substantially perpendicular with respect to the base 184. The organizer can further include opposed first and second side walls 188 and 190 that extend upward along the transverse direction T from the first and second sides 184c and 184d, respectively, of the base 184 and longitudinally forward from the rear wall 186 to the front end 184a of the base 184. In accordance with the illustrated embodiment, the first and second side walls 188 and 190 can be tapered between the rear wall 186 and the front end 184a of the base 184. The rear wall 186, the first side wall 188, and the second side wall 190, respectively, at least partially define a void 192 that is open at the front end 184a of the base, which can be said to be a front end of the organizer 182. The void 192 is configured to receive the plurality of leadframe assemblies 120 when the organizer 182 is attached to the connector housing 112.

The illustrated rear wall 186 defines an inner surface 186a that can be configured to operate as a bias surface 187 that is configured to be placed in mechanical communication with at least one such as all of the alignment ribs 125, such that a biasing force applied by the bias surface 187 is transmitted, either directly or indirectly, to the at least one such as all of the alignment ribs 125. For instance, in accordance with the illustrated embodiment, the bias surface can be configured to make contact with the respective contact surface 129 of each of the alignment ribs 125 of the leadframe housings 122 when the organizer 182 is attached to the connector housing 112 so as to directly apply a biasing force to respective ones, such as all of the leadframe housings 122. For example, the contact surface 129, such as the select location 129a, of each alignment rib 125 can be configured to contact the bias surface 187. It should be appreciated that the bias surface 187 can alternatively be configured to indirectly apply the biasing force to at least one such as all of the alignment ribs 125, for instance through an intermediate structure disposed between the bias surface 187 and the at least one such as all of the alignment ribs 125.

The first and second side walls 188 and 190 define respective inner surfaces 188a and 190a that face the void 192, and respective outer surfaces 188b and 190b that are spaced from the inner surfaces 188a and 190a along the lateral direction A. Respective upper edges of the first and second side walls 188 and 190, respectively, can define beveled surfaces 194 that are angularly offset outward with respect to the inner surfaces 188a and 190a of the first and second side walls 188 and 190, respectively, of the organizer 182 and are configured to guide the plurality of leadframe assemblies 120 into the void 192 when the organizer 182 is attached to the connector housing 112. Similarly, a portion of the inner surface 186a, or bias surface 187 of the rear wall 186 can define a curved alignment surface 195 that extends into the void 192 from an upper edge of the rear wall. The curved alignment surface 195 can be configured to make contact with the respective alignment surfaces 124g of the housing bodies 124 of the respective leadframe housings 122 of the plurality of leadframe assemblies 120, so as to provide an initial, or rough alignment of the plurality of leadframe assemblies 120 with respect to the connector housing 112.

The organizer 182 can define a plurality of openings that are configured to receive respective ones of the mounting ends 130 of the signal contacts 116 or the ground mounting ends 160 of the crosstalk shields 148. In accordance with the illustrated embodiment, base 184 of the organizer 182 defines a plurality of openings as slots 196 that extend through the base 184 of the organizer along substantially the transverse direction T and are elongate along the longitudinal direction L, and thus along the mating direction M. Each slot can define respective inner edges 198 that can be beveled, or angularly offset with respect to the transverse direction T, such that the slot 196 narrows between the inner and outer surfaces 184e and 184f, respectively, of the base 184. In accordance with the illustrated embodiment, each slot 196 defines a dimension along the lateral direction A that shortens as the slot 196 extends from the void 192 through the base 184. For instance, each slot 196 can define a width along the lateral direction A that narrows from a first value at the inner surface 184e of the base 184 that is larger than the respective thicknesses TS and TG of the mounting ends 130 of the signal contacts 116 and the ground mounting ends 160 of the crosstalk shields 148, respectively, to a second value at the outer surface 184f of the base 184 that is smaller than the first value and can be substantially equal to, such as slightly larger than, the respective thicknesses TS and TG of the mounting ends 130 and the ground mounting ends 160, respectively.

As described above, an electrical connector can be constructed with stack tolerances that cause the mounting ends of respective electrical contacts of the electrical connector to be out of lateral alignment with the respective vias of a substrate to which the electrical connector is to be mounted. In accordance with the illustrated embodiment, when the organizer 182 is attached to the connector housing 112, such that the mounting ends 130 of the signal contacts 116 and the ground mounting ends 160 of the crosstalk shields 148 are received in respective ones of the slots 196, the slots 196, for instance the inner edges 198 of the slots 196, can cause one or more respective ones of the mounting ends 130 to be biased along a direction that is substantially perpendicular with respect to the mating direction M and can be, for instance, the lateral direction A, such that the one or more respective ones of the mounting ends 130 are brought into alignment relative to each other along the mating direction M in a predetermined spatial relationship. For instance, the predetermined spatial relationship can be the spacing along the lateral direction A between adjacent columns of mounting ends 130 or ground mounting ends 160, can be alignment of the respective mounting ends 130 or ground mounting ends 160 in a select column with respect to each other, or any combination thereof.

Similarly, the slots 196 can cause one or more respective ones of the ground mounting ends 160 to biased along a direction that is angularly offset with respect to the mating direction M and can be, for instance, the lateral direction A, such that the one or more respective ones of the ground mounting ends 160 are brought into alignment with respect to each other along the mating direction M. In this regard, slots 196 can operate to bias respective ones of the mounting ends 130 of the signal contacts 116 into alignment with respective ones of the electrical signal vias 208 of the substrate 200, and can operate to bias respective ones of the ground mounting ends 160 of the crosstalk shields 148 into alignment with respective ones of the electrical ground vias 210 of the substrate 200, such that the mounting ends 130 and the ground mounting ends 160 can be inserted, such as press fit, into corresponding electrical signal vias 208 and electrical ground vias 210.

Selected ones, such as all of the slots 196 can define respective lengths along the longitudinal direction L that are longer than the maximum cross-sectional dimension CS of the mounting ends 130 and the maximum cross-sectional dimension CG of the ground mounting ends 160, such that the mounting ends 130 and the ground mounting ends 160 are moveable, for instance translatable, within corresponding ones of the slots 196, for instance when respective ones of the leadframe housings 122 are biased toward the contact block 170 along the mating direction M. The slots 196 can be arranged into columns along the longitudinal direction L and rows along the lateral direction A. For instance, the base 184 can define respective columns and rows of slots 196c that are configured to receive the ground mounting ends 160 of respective ones of the third leadframe assemblies 120c, respective columns and rows of slots 196a that are configured to receive the mounting ends 130 of respective ones of the first leadframe assemblies 120a, and respective columns and rows of slots 196b that are configured to receive the mounting ends 130 of respective ones of the second leadframe assemblies 120b. The geometric centers of the slots 196a, 196b, and 196c, respectively, can be arranged along the base 184 so as to be substantially aligned with corresponding ones of the electrical signal vias 208 and electrical ground vias 210 of the substrate 200 when the organizer 182 is attached to the connector housing 112 and electrical connector 102 is mounted to the substrate 200. It should be appreciated that the organizer 182 is not limited to the illustrated geometries of the plurality of openings, and that the organizer 182 can define openings having any other suitable geometry as desired.

The organizer 182 can include at least one guide member, such as a pair of guide members 199 that are configured to engage with complementary guide members of the connector housing 112 when the organizer 182 is attached to the connector housing 112, the guide members 199 and the complementary guide members configured to align the organizer 182 with respect to the connector housing 112. In accordance with the illustrated embodiment, the organizer 182 includes a pair of guide members 199 including a first guide post 199a that extends out from the outer surface 188b of the first side wall 188 and a second guide post 199b that extends out from the outer surface 190b of the second side wall 190.

Further in accordance with the illustrated embodiment, the connector housing includes a pair of guide members 109 including a first guide recess 109a that extends into the inner surface 174a of the first side wall 174 of the connector housing 112 and is configured to receive the first guide post 199a, and a second guide recess 109b that extends into the inner surface 176a of the second side wall 176 and is configured to receive the second guide post 199b. The organizer 182 can be said to be attached to the connector housing 112 in accordance with a predetermined spatial relationship when the first and second guide posts 199a and 199b are received in the first and second guide recesses 109a and 109b, respectively.

The first and second guide posts 199a and 199b can be sized to interfere with the first and second guide recesses 109a and 109b, respectively, when the organizer 182 is attached to the connector housing 112. In this regard, the guide members 199 and 109, respectively, can operate to retain the organizer 182 in an attached position with respect to the connector housing 112. It should be appreciated that the organizer 182 and the connector housing 112 are not limited to the illustrated guide members 199 and 109. For example, the organizer 182 can be alternatively constructed to define first and second guide recesses, and the connector housing 112 can be alternatively constructed to define first and second guide posts configured to be received in the first and second guide recesses of the organizer. It should further be appreciated that the organizer 182 and the connector housing 112 are not limited to the illustrated first and second guide recesses 109a and 109b and first and second guide posts 199a and 199b, and that the organizer 182 and the connector housing 112 can be alternatively constructed having any other suitable guide members as desired, or can be constructed without guide members.

Referring now also to FIGS. 3A-3C, in accordance with the illustrated embodiment the second abutment surface 123 of the leadframe housing 122 of each of leadframe assembly 120 can be spaced from the rear end 124b of the housing body 124, and thus the outer surface 127, a first distance L1 along the mating direction M. It should be appreciated that when the first and second abutment surfaces 111 and 123, respectively, abut each other the outer surface 127 and the first abutment surface 111 can similarly define the first distance L1. Furthermore, the second abutment surface 123 of the leadframe housing 122 of each of leadframe assembly 120 can be spaced from the contact surface 129 of the alignment rib 125, for instance the select location 129a of the contact surface 129, a second distance L2 along the mating direction M. It should be appreciated that when the first and second abutment surfaces 111 and 123, respectively, abut each other the contact surface 129 and the first abutment surface 111 can similarly define the second distance L2. In accordance with the illustrated embodiment, each of the first, second, and third leadframe assemblies 120a, 120b, and 120c define respective first distances L1 that are substantially equal to each other and respective second distances L2 that are substantially equal to each other. It should be appreciated that the one or both of the respective first and second distances L1 and L2 defined by the leadframe assemblies 120 can differ from leadframe assembly to leadframe assembly, for instance due to manufacturing discrepancies.

Further in accordance with the illustrated embodiment, when the organizer 182 is attached to the connector housing 112, the bias surface 187 of the rear wall 186 of the organizer 182 can be spaced from the first abutment surface 111 of the connector housing 112 a third distance L3 along the mating direction M that is longer than or substantially equal to, and not shorter than, the first distance L1 and that is shorter than or substantially equal to, and preferably not longer than, the second distance L2, such that the bias surface 187 will engage with the alignment rib 125 of the leadframe housing 122 of at least one such as each of the plurality of leadframe assemblies 120 when the organizer 182 is attached to the connector housing 112, such that the bias surface 187 biases at least one of the plurality of leadframe assemblies 120 toward the first abutment surface 111. Otherwise stated, the third distance L3 can be substantially between the first and second distances L1 and L2, respectively, which includes substantially equal to at least one or both of the respective first and second distances L1 and L2 defined by various ones of the plurality of leadframe assemblies 120.

In operation, when the organizer 182 is attached to the connector housing 112, the inner surface 186a, or bias surface 187 of the rear wall 186 faces the respective outer surfaces 127 of the leadframe housings 122 of the plurality of leadframe assemblies 120 supported by the connector housing 112. As the organizer 182 is attached to the connector housing 112, for instance by inserting the first and second guide posts 199a and 199b into the first and second guide recesses 109a and 109b, respectively, along the transverse direction T, the curved alignment surface 195 of the rear wall 186 can engage with the alignment surfaces 124g of the housing bodies 124 of at least one, such as a plurality up to all of the of the plurality of leadframe assemblies 120, causing the plurality of leadframe assemblies 120 to be biased into an initial, or rough alignment with respect to each other and with respect to the contact block 170 of the connector housing 112.

As the organizer 182 is further attached to the connector housing 112, the bias surface 187 can translate substantially parallel to, for example riding along, the outer surfaces 127 of respective ones of the leadframe assemblies such that the bias surface 187 comes into contact with at least one, such as a plurality of up to all of the alignment ribs 125 of the plurality of leadframe assemblies 120. In accordance with the illustrated embodiment, because the third distance L3 is substantially between the first and second distances L1 and L2, respectively, contact between the contact surfaces 129 of respective ones of the alignment ribs 125 and the bias surface 187 causes the respective rear ends 124b of the housing bodies 124 of the leadframe housings 122 to translate longitudinally forward toward the contact block 170 of the connector housing 112, thereby causing the respective leadframe assemblies 120 to translate forward within the connector housing 112 along the longitudinal direction L until the respective second abutment surfaces 123 of the leadframe assemblies 120 abut the first abutment surface 111 of the contact block 170. In this regard, the rear wall 186 can be referred to as a bias wall.

In situations where one or more such as all of the leadframe housings 122 defines a second distance L2 that is longer than the third distance L3, the respective alignment ribs 125 of the one or more leadframe housings 122 can be configured to be compressed, or crushed by the bias surface 187. Each alignment rib 125 can define a first state in which the bias surface 187 has not yet been placed in mechanical communication with the alignment rib 125. Subsequently, when the bias surface 187 makes contact with the alignment rib 125, for instance when the organizer 182 is attached to the connector housing 112, at least a portion of the alignment rib 125 can be compressed, or crushed inward toward the outer surface 127 of the leadframe housing 122 by the bias surface 187 to a second state that is compressed along the mating direction M relative to the first state, such that the leadframe housing 122 is biased forward along the mating direction M until the first and second abutment surfaces 111 and 123, respectively, abut each other. It should be appreciated that each alignment member 125 can be compressed from the first state to the second state before, substantially at the same time as, or after the first and second abutment surfaces 111 and 123, respectively, abut each other.

When the alignment rib 125 is compressed to the second state, the second abutment surface 123 and the contact surface 129 of the leadframe housing 122 can be spaced a fourth distance along the mating direction M that can be substantially equal to the third distance L3. In this regard, the fourth distance can be said to be substantially equal to the second distance L2 reduced, through compression of the alignment rib 125, to substantially the third distance L3. The alignment ribs 125 can thus be referred to as compression ribs, such as crush ribs. It should be appreciated that the alignment ribs 125 of respective ones of the leadframe housings 122 can maintain varying degrees of integrity as the organizer 182 is attached to the connector housing 112. For example, when the respective second abutment surface 123 of each of the plurality of leadframe housings 122 abuts the first abutment surface 111, such that the plurality of leadframe assemblies 120 are fully inserted and aligned with respect to the contact block 170 of the connector housing 112, respective ones of the alignment ribs 125 may compressed by approximately eighty percent, while respective other ones of the alignment ribs 125 may not be compressed at all, for example depending upon manufacturing tolerances of the leadframe assemblies 120.

It should be appreciated that a method of aligning respective mounting ends of a plurality of electrical contacts of an electrical connector, for instance the mounting ends 130 of the signal contacts 116 and the ground mounting ends 160 of the crosstalk shields 148, along one or both of the lateral direction A and the longitudinal direction L can include the step of providing an electrical connector 102 that includes a connector housing 112 that defines a first abutment surface 111, an organizer 182 configured to attach to the connector housing 112, and a plurality of leadframe housings 122 configured to be supported by the connector housing 112. Each leadframe housing 122 can include a housing body 124 that defines a respective second abutment surface 123 and an outer surface 127 that is spaced from the second abutment surface 123 along the longitudinal direction L. Each leadframe housing 122 can further include at least one, such as a plurality of alignment members, such as the alignment ribs 125 that project from the outer surfaces 127 of respective ones of the plurality of leadframe housings 122. The method can further include the step of disposing the plurality of leadframe housings 122 into a void 178 defined by the connector housing 112. The method can further include the step of attaching the organizer 182 to the connector housing 112, such that the organizer 182 biases the plurality of leadframe housings 122 toward the first abutment surface 111 so as to cause the respective second abutment surfaces 123 to abut the first abutment surface 111. In accordance with the method, attaching the organizer 182 to the connector housing 112 can further cause the organizer 182 to compress the respective alignment members of at least one, such as each of the plurality of leadframe housings 122.

It should be appreciated that the electrical connector 102 is not limited to the illustrated locations of the alignment ribs 125, such as protruding from the outer surfaces 127 of the rear ends 124b of the housing bodies 124 of the leadframe housings 122. For example, in accordance with an alternative embodiment the leadframe housings 122 can be alternatively constructed omitting the alignment ribs 125, and the organizer 182 can be alternatively constructed with at least one, such as a plurality of alignment ribs that extend from the inner surface 186a of the rear wall 186. In accordance with another alternative embodiment, both the outer surfaces 127 of the rear ends 124b of the housing bodies 124 of the leadframe housings 122 and the inner surface 186a of the rear wall 186 of the organizer 182 can support respective alignment ribs. The alignment ribs can be arranged along the outer surfaces 127 and the inner surface 186a in an alternating pattern along the lateral direction A, can be aligned along the outer surfaces 127 and the inner surface 186a so as to engage with one another when the organizer 182 is attached to the connector housing 112, or any combination thereof Accordingly, it can be said that the electrical connector 102 includes at least one such as a plurality of alignment members that are disposed between the leadframe housings 122 and the organizer 182. For instance, in accordance with the illustrated embodiment, the electrical connector 102 can include at least one such as a plurality of alignment ribs 125 that are disposed between the outer surfaces 127 of the housing bodies 124 of respective ones of the leadframe housings 122 and the bias surface 187 defined by the rear wall 186 of the organizer 182. It should further be appreciated that the electrical connector 102 can be constructed such that the at least one or more alignment ribs 125 are not integral or monolithic with one or both of the leadframe housings 122 and the organizer 182. For instance, the alignment ribs 125 can be discrete alignment members that are disposed between the leadframe housings 122 and the organizer 182, for example when the organizer 182 is attached to connector housing 112.

Moreover, the electrical connector is not limited to the illustrated bias surface 187 defined by the rear wall 186 of the organizer 182. For example, it should be appreciated that the connector housing 112 can define a rear wall that is rearwardly spaced from the contact block 170, and thus spaced from the first abutment surface 111, along the longitudinal direction L. The rear wall of the connector housing 112 can define the bias surface that makes contact with the alignment members, such as the alignment ribs 125 so as to bias the leadframe housings 122 forward along the longitudinal direction L until the second abutment surfaces 123 of the respective leadframe housings 122 abut the first abutment surface 111 of the connector housing 112, and causes a select one or more up to all of the alignment ribs 125 to compress in the manner described above. Accordingly, it should be appreciated that the electrical connector 102 can include alignment ribs 125 that align respective ones of the mounting ends 130 and the ground mounting ends 160 of the plurality of the electrical contacts 114 along the lateral direction A. The electrical connector 102 can include the alignment ribs 125 alone or in combination with the organizer 182. The electrical connector 102 can include the organizer 182, which aligns respective ones of the mounting ends 130 and the ground mounting ends 160 of the plurality of the electrical contacts 114 along the longitudinal direction L. The electrical connector 102 can include the organizer 182 alone or in combination with the alignment ribs 125.

When the plurality of leadframe assemblies 120 are disposed in the void 178 and fully inserted with respect to the connector housing 112 such that the second abutment surface 123 of each leadframe housing 122 abuts the first abutment surface 111, the mating ends 128 of the plurality of signal contacts 116 and the ground mating ends 158 of the plurality of crosstalk shields 148 are substantially aligned with respect to each other along the transverse direction T and the longitudinal direction L, so as to define respective rows of mating ends 128 and ground mating ends 158 along the row direction R that are disposed in the first and second receptacle pockets 108a and 108b. In this regard, the repeating pattern of leadframe assemblies 120 defines a repeating pattern of ground contact 118, signal contact 116, signal contact 116 (G-S-S) from left to right across the mating interface 108, from the second side wall 176 to the first side wall 174 of the connector housing 112. Moreover, when the plurality of leadframe assemblies 120 are disposed in the void 178 and fully inserted with respect to the connector housing 112, the front ends 124a of the respective leadframe housings 122 of each of the first, second, and third leadframe assemblies 120a, 120b, and 120c are substantially aligned along a plane defined by the transverse direction T and the lateral direction A, such that the mounting ends 130 and the ground mounting ends 160 of the electrical connector 102 are properly aligned such that the electrical connector 102 can be mounted to the substrate 200.

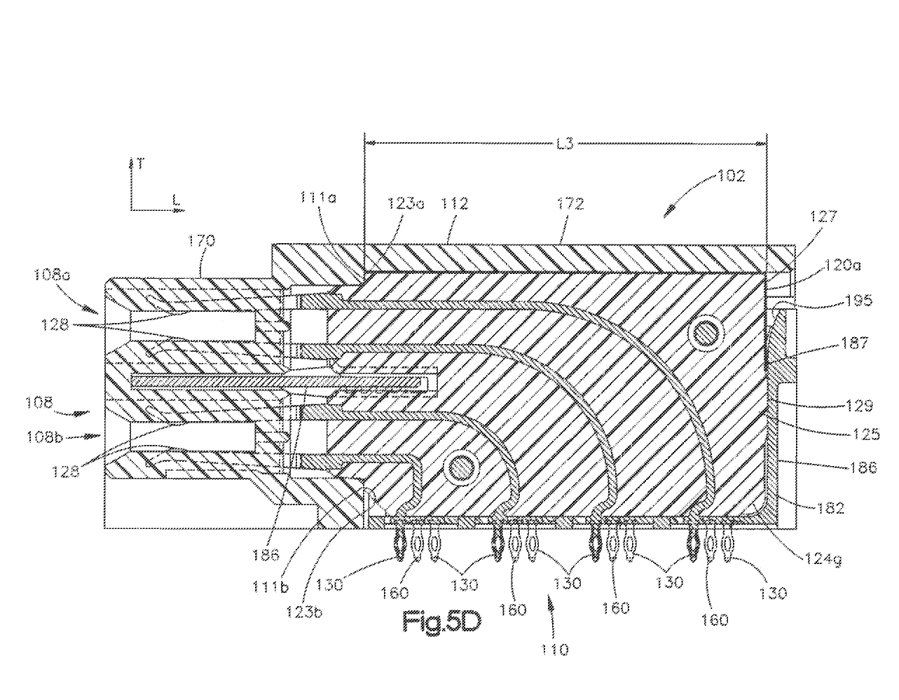

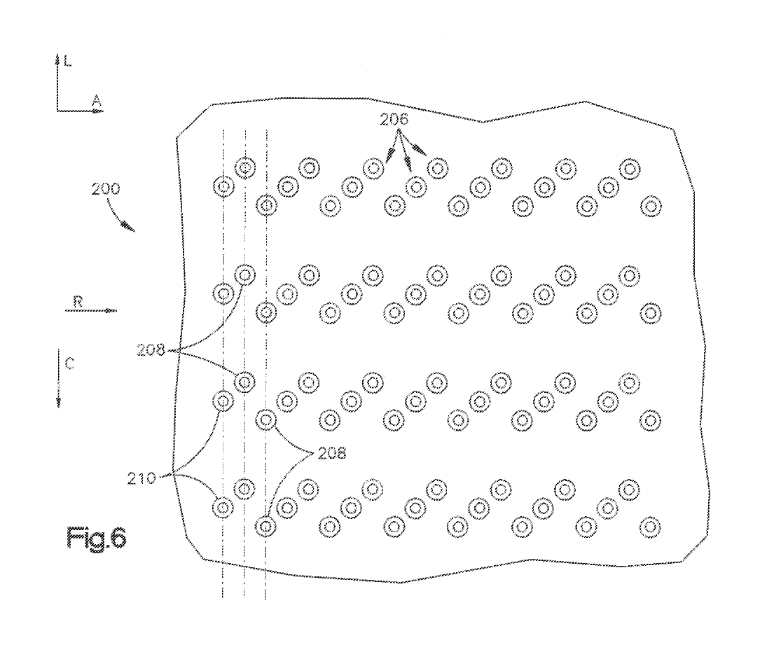

Referring now to FIG. 6, the substrate 200 can include at least one such as a plurality of electrically conductive elements that can be supported by the substrate 200. The electrically conductive elements can be electrically connected to electrically conductive traces that are routed through the substrate 200 or along one or more surfaces of the substrate 200. In accordance with illustrated embodiment, the substrate 200 includes a plurality of electrically conductive elements, for example a plurality of electrically conductive vias 206 that can be configured as plated through holes that extend into, such as through, the substrate 200 along the transverse direction T. Each of the plurality of vias 206 can be configured to receive a complementary portion of a respective one of the plurality of electrical contacts 114, thereby placing the respective one of the plurality of electrical contacts 114 in electrical communication with the substrate 200. The plurality of vias 206 can include at least one or both of electrical signal vias 208 or electrical ground vias 210, in any combination as desired, for example arranged in accordance with a via footprint configured to receive a corresponding arrangement of the plurality of electrical contacts 114 of the electrical connector 102. The via footprint can include vias 206 arranged into columns of vias 206 along a column direction C that extends substantially parallel to the longitudinal direction L and into rows of vias 206 along a row direction R that extends substantially parallel to the lateral direction A. It should be appreciated that the columns of vias 206 are spaced from each other along the row direction R, and that the rows of vias 206 are spaced apart from each other along the column direction C. The footprint can include respective pluralities of electrical signal vias 208 and electrical ground vias 210.

Referring now to FIGS. 3A-3C and 5D, each first leadframe assembly 120a supports respective ones of the plurality of signal contacts 116 such that the mounting end 130 that is closest to the front end 124a of the housing body 124, that is the mounting end 130 that is closest to the mating interface 108 with respect to the other mounting ends 130 of the first leadframe assembly 120a, is spaced from the front end 124a a distance D1 along the longitudinal direction L. Likewise, each second leadframe assembly 120b supports respective ones of the plurality of signal contacts 116 such that the mounting end 130 that is closest to the front end 124a of the housing body 124 is spaced from the front end 124a a distance D2 along the longitudinal direction L that is longer than the distance D1. Similarly, each third leadframe assembly 120c supports a respective one of the plurality of crosstalk shields 148 such that the ground mounting end 160 that is closest to the front end 124a of the housing body 124 is spaced from the front end 124a a distance D3 along the longitudinal direction L that is longer than the distance D2 but shorter than the distance D3. Accordingly, when respective second abutment surfaces 123 of the plurality of leadframe assemblies 120 abut the first abutment surface 111 of the connector housing 112, the mounting ends 130 and the ground mounting ends 160 of the plurality of leadframe assemblies 120 are aligned with corresponding vias 206 of the via footprint of the substrate 200.

Because each of the distances D1, D2, and D3 are unequal, when the plurality of leadframe assemblies 120 are disposed in the void 178 and fully inserted with respect to the connector housing 112 such that the second abutment surface 123 of each leadframe housing 122 abuts the first abutment surface 111, the mounting ends 130 of the first leadframe assemblies 120a, the mounting ends 130 of the second leadframe assemblies 120b, and the ground mounting ends 160 of the third leadframe assemblies 120c are not laterally aligned with respect to each other. Accordingly, a line that extends along the lateral direction A and passes through the geometric centers of the mounting ends 130 of the first leadframe assemblies 120a does not pass through the geometric centers of the mounting ends 130 of the second leadframe assemblies 120b or the ground mounting ends 160 of the third leadframe assemblies 120c. Similarly, a line that extends along the lateral direction A and passes through the geometric centers of the mounting ends 130 of the second leadframe assemblies 120b does not pass through the geometric centers of the mounting ends 130 of the first leadframe assemblies 120a or the ground mounting ends 160 of the third leadframe assemblies 120c and a line that extends along the lateral direction A and passes through the geometric centers of the ground mounting ends 160 of the third leadframe assemblies 120c does not pass through the geometric centers of the mounting ends 130 of the first leadframe assemblies 120a or the mounting ends 130 of the second leadframe assemblies 120b. Moreover, in accordance with the illustrated embodiment each row of ground mounting ends 160 that extends along the row direction R is flanked by a first row of mounting ends 130 on a first side of the row and a second row of mounting ends 130 on a second side of the row that is opposite the first side, wherein corresponding ones of the mating ends 128 corresponding to the first and second rows of mounting ends 130 define respective differential signal pairs 117.

It should be appreciated that one or more of each of the first leadframe assemblies 120a, the second leadframe assemblies 120b, or the third leadframe assemblies 120c can be alternatively constructed with different distances D1, D2, and D3, respectively, such that the mounting ends 130 or ground mounting ends 160 of respective ones of the first leadframe assemblies 120a, the second leadframe assemblies 120b, or the third leadframe assemblies 120c can be inserted into respective vias 206 of a substrate 200 alternatively constructed with a plurality of vias 206 arranged in accordance with SFF-8642 Specification, Rev. 2.7, Feb. 26, 2010. In this regard, it should be appreciated that the electrical connector 102 can be alternatively constructed so as to be mounting, or footprint compatible with a substrate constructed in accordance with SFF-8642 Specification, Rev. 2.7, Feb. 26, 2010.

Referring now to FIG. 5D, the electrical connector 102 can further include a ground bar 103 that is configured to define a common ground plane within the electrical connector 102. The ground bar 103 has a bar body that defines a front end 103a, a rear end 103b that is spaced from the front end 103a along the longitudinal direction L. The connector housing 112 can be configured to support the ground bar 103 such that the ground bar 103 is disposed proximate the mating interface 108. For example, the ground bar 103 can be supported by the connector housing 112 such that at least a portion of the ground bar 103 is disposed between respective ones of the mating ends 128 of the plurality of signal contacts 116 and the ground mating ends 158 of the plurality of crosstalk shields 148.

In accordance with the illustrated embodiment, a portion of the ground bar 103 that includes the front end 103a can be substantially enclosed in the contact block 170 such that the enclosed portion of the ground bar 103 is disposed between the first and second pairs 144 and 146 of signal contacts 116 and between the first and second pairs 166 and 168 of ground mating ends 158. In this regard, at least the enclosed portion of the ground bar 103 can operate to shield the differential signal pairs 117 defined by the first pairs 144 of signal contacts 116 from electrical interference generated by the differential signal pairs 117 defined by the second pairs 146 of signal contacts 116, and to shield the differential signal pairs 117 defined by the second pairs 146 of signal contacts 116 from electrical interference, or crosstalk, generated by differential signal pairs 117 defined by the first pairs 144 of signal contacts 116. In this regard, the ground bar 103 can operate as a crosstalk shield with respect to differential signal pairs 117 defined by the first and second pairs 144 and 146 of signal contacts 116, respectively.

Referring also now to FIGS. 3A-3C, in accordance with the illustrated embodiment each leadframe housing 122 can define a slot 126 that extends into the housing body 124 along the longitudinal direction L, the slot 126 configured to at least partially receive a respective portion of the ground bar 103. Further in accordance with the illustrated embodiment, at least one, such as each of the plurality of crosstalk shields 148 can define a retention slot 191 that is configured to electrically connect the crosstalk shield 148 to the ground bar, such that each crosstalk shield 148 is placed in electrical communication with the common ground plain of the electrical connector 102, and is further configured to retain the ground bar 103 in the retention slot 191, for example by engagement between the ground bar 103 and retention members 193 supported by the shield bodies 150 of the crosstalk shields 148.

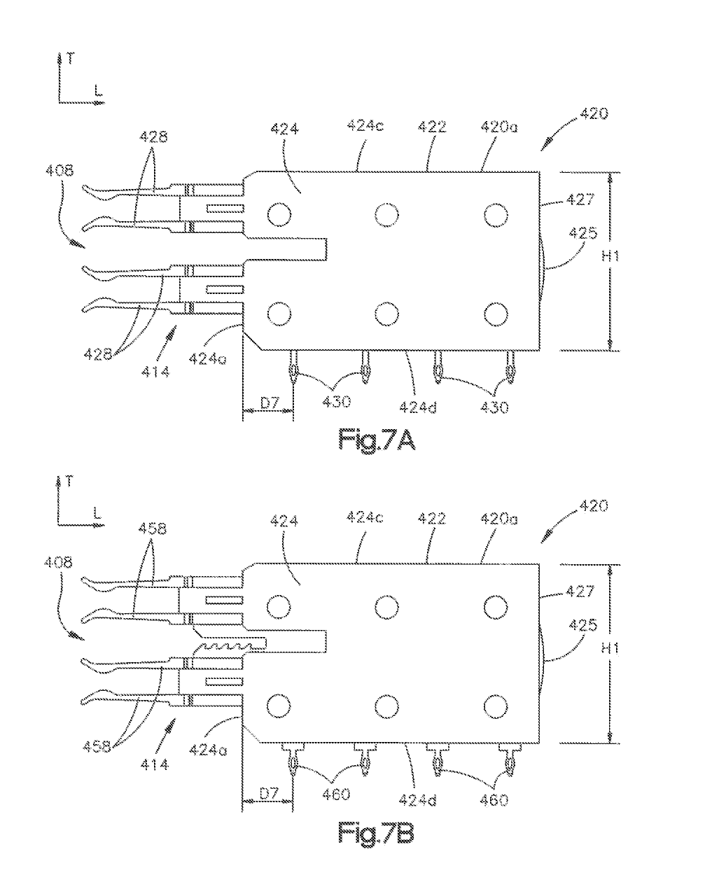

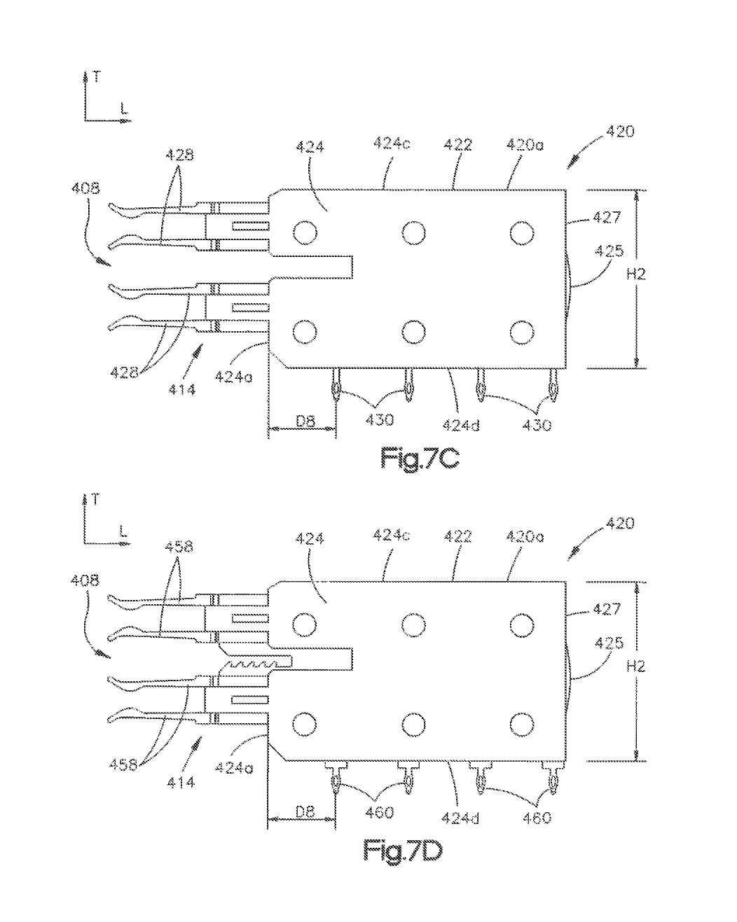

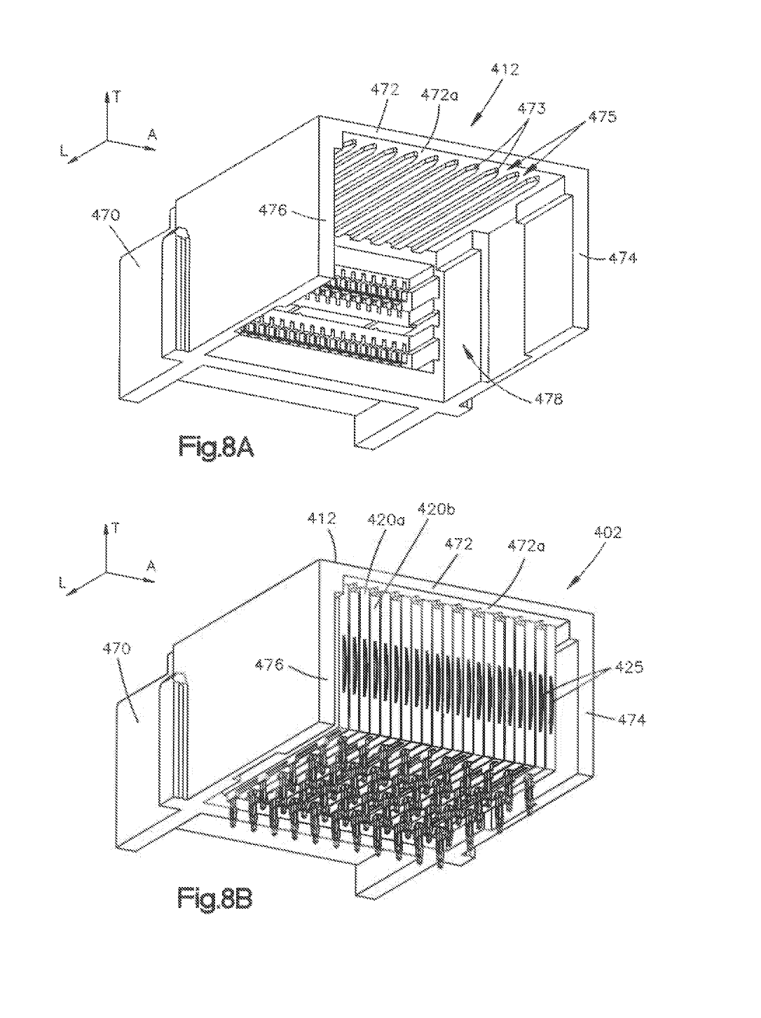

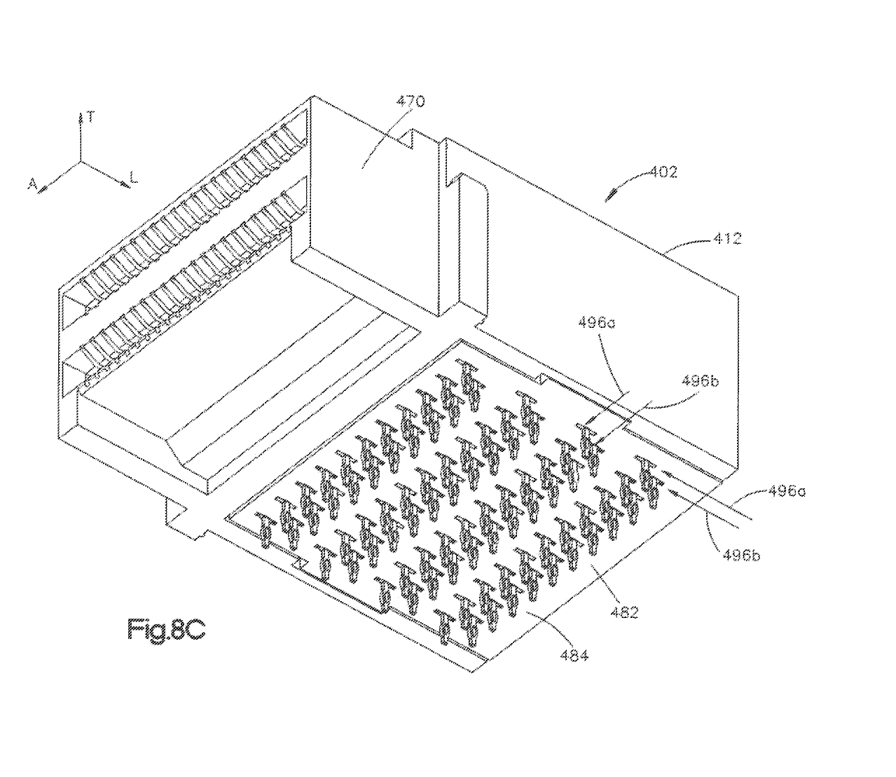

Referring now to FIGS. 7A-7D and 8A-8C, an electrical connector 402 constructed in accordance with an alternative embodiment is illustrated. In the interest of succinctness, elements of the electrical connector 402 that are constructed substantially like corresponding elements of the electrical connector 102 are labeled with reference numbers that are incremented by 300. For example, the electrical connector 402 can include a plurality of leadframe assemblies 420 that constructed similarly to the leadframe assemblies 120. Each leadframe assembly 420 includes a leadframe housing 422 that can support a first alignment member, such as an alignment rib 425 that is constructed substantially the same as the alignment ribs 125 of the electrical connector 102.

The electrical connector 402 can include one or both of two different types of leadframe assemblies, such as a first leadframe assembly 420a and a second leadframe assembly 420b. The first leadframe assembly 420a can be constructed as a signal leadframe assembly or as a ground leadframe assembly. When constructed as a signal leadframe assembly, the first leadframe assembly 420a can support a plurality of electrical contacts 414 designated to operate as signal contacts, the electrical contacts having opposed mating ends 428 and mounting ends 430 (see FIG. 7A). When constructed as a ground leadframe assembly, the first leadframe assembly 420a can support a crosstalk shield having opposed ground mating ends 458 and ground mounting ends 460 (see FIG. 7B). The leadframe housings 422 of each first leadframe assembly 420a define a first height H1 measured along the transverse direction T between the upper and lower ends 424c and 424d, respectively, of the housing body 424. Each first leadframe assembly 420a further defines a first distance D7 measured along the longitudinal direction L between the front end 424a of the housing body 424 of the leadframe housing 422 and the forward most mounting end 430 or ground mounting end 460, that is the mounting end 430 or ground mounting end 460 closest to the mating interface 408 with respect to the other mounting ends 430 or ground mounting ends 460 of the first leadframe assembly 420a.

The second leadframe assembly 420b can be constructed as a signal leadframe assembly or as a ground leadframe assembly. When constructed as a signal leadframe assembly, the second leadframe assembly 420b can support a plurality of electrical contacts 414 designated to operate as signal contacts, the electrical contacts having opposed mating ends 428 and mounting ends 430 (see FIG. 7C). When constructed as a ground leadframe assembly, the second leadframe assembly 420b can support a crosstalk shield having opposed ground mating ends 458 and ground mounting ends 460 (see FIG. 7D). The leadframe housings 422 of each second leadframe assembly 420b define a second height H2 measured along the transverse direction T between the upper and lower ends 424c and 424d, respectively, of the housing body 424. In accordance with the illustrated embodiment, the second height H2 of the leadframe housing 422 of each second leadframe assembly 420b is less than the first height H1 of the leadframe housings 422 of the first leadframe assemblies 420a. However, when the first and second leadframe assemblies 420a and 420b, respectively, are supported by the connector housing 412, the respective mounting ends 430 and ground mounting ends 460 of the first and second leadframe assemblies 420a and 420b are disposed at substantially the same location along the transverse direction T. In other words, the first leadframe assemblies 420a are taller than the second leadframe assemblies 420b.

Each second leadframe assembly 420b further defines a second distance D8 measured along the longitudinal direction L between the front end 424a of the housing body 424 of the leadframe housing 422 and the forward most mounting end 430 or ground mounting end 460, that is the mounting end 430 or ground mounting end 460 closest to the mating interface 408 with respect to the other mounting ends 430 or ground mounting ends 460 of the second leadframe assembly 420b. In accordance with the illustrated embodiment, the second distance D8 is longer than the first distance D7. Thus, the respective mounting ends 430 and ground mounting ends 460 of the first leadframe assemblies 420a are not laterally aligned with the respective mounting ends 430 and ground mounting ends 460 of the second leadframe assemblies 420b. Accordingly, a line that extends along the lateral direction A that passes through the geometric centers of the respective mounting ends 430 and ground mounting ends 460 of the first leadframe assemblies 420a of the electrical connector 402 does not pass through the geometric centers of the respective mounting ends 430 and ground mounting ends 460 of the second leadframe assemblies 420b of the electrical connector 402. Likewise, a line that extends along the lateral direction A that passes through the geometric centers of the respective mounting ends 430 and ground mounting ends 460 of the second leadframe assemblies 420b of the electrical connector 402 does not pass through the geometric centers of the respective mounting ends 430 and ground mounting ends 460 of the first leadframe assemblies 420a of the electrical connector 402. It should be appreciated that as described above with respective to the electrical connector 102, the first and second leadframe assemblies 420a and 420b, respectively, of the electrical connector 402, similarly are not limited to the illustrated alignment ribs 425, and that the respective leadframe housings 422 of the first and second leadframe assemblies 420a and 420b can alternatively be constructed having any other suitable alignment member geometries as desired, or can be constructed with no alignment members.

In accordance with the illustrated embodiment, the electrical connector 402 includes first and second leadframe assemblies 420a and 420b disposed in the connector housing 412 in an alternating arrangement, with respective first leadframe assemblies 420a disposed adjacent the first and second side walls 474 and 476 of the connector housing 412, respectively, such that each first leadframe assembly 420a is disposed adjacent or between a respective one of the second leadframe assemblies 420b, and each second leadframe assembly 420b is disposed between respective ones of the first leadframe assemblies 420a. Respective ones of the first and second leadframe assemblies 420a and 420b can be configured as signal leadframe assemblies or ground leadframe assemblies, such that the plurality of leadframe assemblies 420 defines a repeating pattern of ground leadframe assembly, signal leadframe assembly, signal leadframe assembly, from left to right across the void 478, from the second side wall 476 to the first side wall 474 of the connector housing 112. Alternatively, the electrical connector 402 can be constructed with any combination of first and second leadframe assemblies 420a and 420b, disposed in the connector housing 412 in accordance with any arrangement, as desired. Alternatively still, the leadframe assemblies 420 can be identically constructed, for instance within manufacturing tolerances.

It should be appreciated that the electrical connector 402 can be constructed with leadframe assemblies 420 that do not have crosstalk shields. For instance, the electrical connector 402 can be constructed having a plurality of first and second leadframe assemblies 420a and 420b configured in accordance with the above-described signal leadframe assemblies, that is leadframe assemblies that support respective electrical contacts 414. However the electrical contacts 414 of respective ones of the first or second leadframe assemblies 420a or 420b can be designated as electrical ground contacts rather than as electrical signal contacts. In this regard, the electrical connector 402 can be alternatively constructed as a substantially shieldless electrical connector.

For example, the electrical contacts 414 of a first leadframe 420a disposed in the left most position within the illustrated connector housing 112, adjacent the second side wall 476, can be configured, for instance designated to operate as ground contacts. The electrical contacts 414 carried by the next two leadframe assemblies 420, including a second leadframe assembly 420b and another first leadframe assembly 420a, moving from left to right, can be configured, for instance designated to operate as signal contacts. The electrical contacts 414 of adjacent leadframe assemblies 420 configured as signal leadframe assemblies can define respective broadside-coupled differential signal pairs, and laterally adjacent differential signal pairs can be separated by respective electrical contacts 414 configured as ground contacts. Accordingly, the electrical contacts 414 can be arranged in a repeating ground-signal-signal configuration, though it should be appreciated that the electrical contacts 414 can be configured in any manner as desired. For instance, the electrical connector 402 can be constructed such that the electrical contacts 414 define edge-coupled differential signal pairs spaced along respective columns of electrical contacts 414, and can be configured in any pattern of ground contacts and signal contacts as desired. Alternatively still, the electrical contacts 414 can define single-ended signal contacts.

The inner surface 472a of the upper wall 472 of the organizer 482 of the electrical connector 402 defines a plurality of ribs 473 that are elongate along the longitudinal direction and spaced apart along the lateral direction A, and can terminate in tapered ends near the rear of the connector housing 412 opposite the contact block 470. The ribs 473 can be laterally spaced so as to define channels 475 that have respective widths along the lateral direction A that are substantially equal to respective widths of the leadframe housings 422 of the first leadframe assemblies 420a. The channels 475 can be configured to receive the first leadframe assemblies 420a as they are disposed into the connector housing 412. The ribs 473 can define respective widths along the lateral direction A that are substantially equal to respective widths of the leadframe housings 422 of the second leadframe housings 420b, and can extend down from the inner surface 472a of the upper wall 472 along the transverse direction T through a distance so as to receive respective ones of the second leadframe assemblies 420b thereunder, such that the lower ends 424d of the housing bodies 424 of the second leadframe assemblies 420b will substantially align with the lower ends 424d of the housing bodies 424 of the first leadframe assemblies 420a when the plurality of leadframe assemblies 420 is disposed in the connector housing 412. For example, as illustrated in FIG. 8B, respective pluralities of first and second leadframe assemblies 420a and 420b are disposed adjacent each other in the connector housing 412 in an alternating pattern.

The slots 496 of the organizer 482 can be constructed substantially the same as the slots 196 of the organizer 182, and can be arranged into columns along the longitudinal direction L and rows along the lateral direction A. For instance, the base 484 of the organizer 482 can define respective columns and rows of slots 496a that are configured to receive the mounting ends 430 and ground mounting ends 460 of respective ones of the first leadframe assemblies 420a and columns and rows of slots 496b that are configured to receive the mounting ends 430 and ground mounting ends 460 of respective ones of the second leadframe assemblies 420b. The geometric centers of the slots 496a and 496b, respectively, can be arranged along the base 484 so as to be substantially aligned with corresponding ones of electrical signal vias and electrical ground vias of a substrate constructed in accordance with SFF-8642 Specification, Rev. 2.7, Feb. 26, 2010, when the organizer 482 is attached to the connector housing 412 and electrical connector 402 is mounted to the substrate. In this regard, it can be said that the electrical connector 402 is both mating compatible and mounting compatible complementary electrical components constructed in accordance with SFF-8642 Specification, Rev. 2.7, Feb. 26, 2010. It should be appreciated that while the first and second alignment members are described herein in accordance with embodiments of electrical connectors that are one or both of mating and mounting compatible with CXP electrical connectors, that any other type of electrical connector can be constructed using one or both of the first and second alignment members.

The foregoing description is provided for the purpose of explanation and is not to be construed as limiting the electrical connector. While various embodiments have been described with reference to preferred embodiments or preferred methods, it is understood that the words which have been used herein are words of description and illustration, rather than words of limitation. Furthermore, although the embodiments have been described herein with reference to particular structure, methods, and embodiments, the electrical connector is not intended to be limited to the particulars disclosed herein. For instance, it should be appreciated that structure and methods described in association with one embodiment are equally applicable to all other embodiments described herein unless otherwise indicated. Those skilled in the relevant art, having the benefit of the teachings of this specification, may effect numerous modifications to the electrical connector as described herein, and changes may be made without departing from the spirit and scope of the electrical connector, for instance as set forth by the appended claims.

What is claimed:

1. An electrical connector configured to mate with a complementary electrical connector along a mating direction, the electrical connector comprising:
a plurality of leadframe assemblies each including a dielectric leadframe housing that defines an outer surface, and a plurality of electrical contacts supported by the leadframe housing, each of the plurality of electrical contacts having a mounting end;
an organizer defining a plurality of openings, each opening configured to receive the mounting end of a corresponding one of the plurality of electrical contacts; and
an alignment member disposed between the outer surface of at least one of the plurality of leadframe housings and the organizer such that the organizer contacts the alignment member so as to bias the at least one leadframe housing along the mating direction, thereby aligning the at least one leadframe housing with at least another one of the plurality of leadframe housings along a second direction that is perpendicular to the mating direction,
wherein the plurality of openings cause respective ones of the mounting ends of the plurality of electrical contacts to align relative to each other along the mating direction.

2. The electrical connector of claim 1, wherein the alignment member extends from the outer surface of the particular one of the plurality of leadframe housings.

3. The electrical connector of claim 2, wherein the alignment member is compressible, and configured to be compressed by the organizer.

4. The electrical connector of claim 3, wherein the alignment member is plastically compressible, and is crushed at a location between the organizer and the outer surface of the at least one of the plurality of leadframe housings.

5. The electrical connector of claim 3, wherein the alignment member comprises a rib.

6. The electrical connector of claim 5, wherein the rib defines a curved contact surface that is configured to contact the organizer.

7. The electrical connector of claim 6, wherein the rib extends out from the outer surface of the at least one of the plurality of leadframe housings.

8. The electrical connector of claim 7, wherein the rib is plastically compressible, and is crushed at a location between the organizer and the outer surface of the at least one of the plurality of leadframe housings.

9. The electrical connector of claim 2, wherein the plurality of leadframe housings at least partially define a mounting interface of the electrical connector and the outer surface of each of the plurality of leadframe housings is oriented substantially perpendicular with respect to the mounting interface.

10. The electrical connector of claim 1, wherein each of the plurality of openings comprises a slot, each slot configured to receive the mounting end of a corresponding one of the plurality of electrical contacts such that the mounting end is movable within the slot along the mating direction.

11. The electrical connector of claim 10, wherein the mounting end of each of the plurality of electrical contacts defines a press-fit tail.

12. An electrical connector configured to mate with a complementary electrical connector along a mating direction, the electrical connector comprising:
a connector housing defining a first abutment surface;
a plurality of leadframe assemblies configured to be supported by the connector housing, each leadframe assembly having a leadframe housing, the leadframe housing of at least one of the plurality of leadframe assemblies defining an outer surface and a second abutment surface configured to abut the first abutment surface;
a bias surface that faces the outer surface; and
an alignment member disposed between the outer surface and the bias surface, the alignment member defining a contact surface that is in mechanical communication with the bias surface, the alignment member configured to compress from a first state to a second state,
wherein the outer surface and the second abutment surface are spaced from each other a first distance along the mating direction, the contact surface and the second abutment surface are spaced a second distance along the mating direction, the second distance longer than the first distance, and the bias surface and the first abutment surface are spaced apart a third distance along the mating direction, the third distance between the first and second distances when 1) the alignment member is in the first state and 2) the bias surface defines a predetermined spatial relationship with respect to the connector housing,
such that when the bias surface defines the predetermined spatial relationship, the bias surface applies a force to the contact surface that 1) compresses the alignment member from the first state to the second state, and 2) biases the at least one of the plurality of leadframe assemblies toward the first abutment surface.

13. The electrical connector of claim 12, wherein the bias surface causes the alignment member to compress such that the contact surface and the first abutment surface define a fourth distance therebetween.

14. The electrical connector of claim 13, wherein the alignment member comprises a rib that projects out from the outer surface.

15. The electrical connector of claim 13, wherein the contact surface is curved so as to define an apex that is configured to contact the bias surface.

16. The electrical connector of claim 12, wherein the bias surface biases the at least one leadframe assembly toward the first abutment surface until the second abutment surface abuts the first abutment surface.

17. The electrical connector of claim 12, wherein each of the leadframe assemblies includes a plurality of electrical contacts supported by the leadframe housing, each electrical contact having a mounting end, and the electrical connector further comprises an organizer configured to be attached to the connector housing, the organizer defining a plurality of openings, each opening configured to receive the mounting end of a corresponding one of the plurality of electrical contacts so as to bias the mounting end along a second direction that is substantially perpendicular to the mating direction.

18. The electrical connector of claim 17, wherein the mounting ends each define a maximum cross-sectional dimension along the mating direction and each of the plurality of openings defines a respective length along the mating direction that is longer than the maximum cross-sectional dimension, such that each mounting end is movable along the mating direction the opening.

19. The electrical connector as recited in claim 17, wherein the organizer defines the bias surface, and the predetermined spatial relationship is defined when the organizer is attached to the connector housing.

20. The electrical connector of claim 19, wherein the organizer comprises a base that defines the plurality of openings and a rear wall that defines the bias surface.

21. The electrical connector of claim 20, wherein the rear wall is oriented substantially perpendicular with respect to the base.

22. The electrical connector of claim 17, wherein at least one of the plurality of leadframe assemblies comprises a crosstalk shield that has a shield body and a plurality of ground mounting ends that extend from the shield body, and wherein respective ones of the plurality of openings are configured to receive corresponding ones of the ground mounting ends of the crosstalk shield so as to bias the ground mounting ends along the second direction.

23. A method comprising:
providing an electrical connector that includes a connector housing that defines a first abutment surface, an organizer configured to attach to the connector housing, and a plurality of leadframe housings configured to be supported by the connector housing, each leadframe housing including a housing body that defines a respective second abutment surface and an outer surface that is spaced from the second abutment surface, each leadframe housing further including an alignment member that projects from the outer surface;
disposing the plurality of leadframe housings into the connector housing; and
attaching the organizer to the connector housing, such that the organizer biases the plurality of leadframe housings toward the first abutment surface so as to cause the respective second abutment surfaces to abut the first abutment surface.

24. The method of claim 23, wherein attaching the organizer to the connector housing further causes the organizer to compress the respective alignment member of at least one of the plurality of leadframe housings.
